(19) United States
(12) Patent Application Publication
(10) Pub. No.: US 2026/0197470 A1
(43) Pub. Date: Jul. 9, 2026

(54) COOPERATIVE ENCODER SUPPORT IN VIDEO BITSTREAM

(71) Applicant: Tencent America LLC, Palo Alto, CA (US)

(72) Inventors: Stephan WENGER, Hillsborough, CA (US); Roman CHERNYAK, Santa Clara, CA (US)

(73) Assignee: Tencent America LLC, Palo Alto, CA (US)

(21) Appl. No.: 19/367,737

(22) Filed: Oct. 23, 2025

Related U.S. Application Data
(60) Provisional application No. 63/742,843, filed on Jan. 7, 2025.

(51) Int. Cl. H04N 19/189; H04N 19/172; H04N 19/70

(52) U.S. Cl. CPC H04N 19/189; H04N 19/172; H04N 19/70

(57) ABSTRACT

Some aspects of the disclosure provide a method of video decoding. In an example, a video bitstream is received, he bitstream includes coded information of one or more pictures. From the video bitstream, at least a first syntax element that indicates a worst-case decoding complexity for the video bitstream is decoded. Further, from the video bitstream, at least a second syntax element is decoded, at least the second syntax element indicates a decoding complexity that is chosen by an encoder to generate at least a portion of the coded information with the decoding complexity. The decoding complexity chosen by the encoder is lower than the worst-case decoding complexity. The one or more pictures are reconstructed based on at least the first syntax element and at least the second syntax element.

### INCORPORATION BY REFERENCE

The present application claims the benefit of priority to U.S. Provisional Application No. 63/742,843, filed on January 7, 2025. The entire disclosure of the prior application is hereby incorporated by reference in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

Some aspects of the disclosure provide a method of video decoding. In an example, a video bitstream is received, he bitstream includes coded information of one or more pictures. From the video bitstream, at least a first syntax element that indicates a worst-case decoding complexity for the video bitstream is decoded. Further, from the video bitstream, at least a second syntax element is decoded, at least the second syntax element indicates a decoding complexity that is chosen by an encoder to generate at least a portion of the coded information with the decoding complexity. The decoding complexity chosen by the encoder is lower than the worst-case decoding complexity. The one or more pictures are reconstructed based on at least the first syntax element and at least the second syntax element.

Some aspects of the disclosure provide a method for video encoding. In an example, among coding tools that are available under a set of restrictions, a subset of coding tools is selected, the subset of coding tools has a decoding complexity that is lower than a worst-case decoding complexity of the coding tools. At least a source picture is encoded into coded information in a video bitstream by using the subset of coding tools. At least a first syntax element that is indicative of the set of restrictions, and at least a second syntax element that is indicative of the decoding complexity are included, into the video bitstream.

Aspects of the disclosure also provide an apparatus for video decoding. The apparatus for video encoding including processing circuitry configured to implement any of the described methods for video decoding.

Aspects of the disclosure also provide an apparatus for video encoding. The apparatus for video encoding including processing circuitry configured to implement any of the described methods for video encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 shows a block diagram of a communication system according to an aspect of the present disclosure.

FIG. 2 shows an example for an application a video encoder and decoder in a streaming environment according to some aspects of the disclosure.

FIG. 3 shows a block diagram of a video decoder according to an aspect of the present disclosure.

FIG. 4 shows a block diagram of a video encoder according to some aspects of the present disclosure.

FIG. 5 shows a layout of a coded video sequence (CVS) in some examples.

FIG. 6 shows a diagram for a temporal scalability in some examples.

FIG. 7 shows an example of a prediction structure using temporal, spatial, and SNR layers according to an aspect of the disclosure.

FIGS. 8A-8D show examples of coded video sequences according to some aspects of the disclosure.

FIG. 9 shows a syntax structure according to some aspects of the disclosure.

FIG. 10 shows a syntax structure according to some aspects of the disclosure.

FIG. 11 shows a diagram of complex management according to some aspects of the disclosure.

FIG. 12 shows a flow chart outlining a decoding process according to some aspects of the disclosure.

FIG. 13 shows a flow chart outlining an encoding process according to some aspects of the disclosure.

FIG. 14 is a schematic illustration of a computer system in accordance with an aspect.

### DETAILED DESCRIPTION

Some aspects of the disclosure provide techniques of video encoding and decoding, such as scalable encoding and decoding techniques involving a base layer of low complexity and enhancement layer(s) of higher complexity.

Some aspects of the disclosure provide techniques for reconstructing a video bitstream created by a cooperative encoder. In an example, the techniques include decoding at least one first syntax element indicative of a worst-case complexity of a bitstream or part thereof that is higher than the complexity a decoder can reconstruct, decoding at least one second syntax element indicative of the encoder has created the bitstream such that the decoding complexity of the bitstream or part thereof is lower than the worst case decoding complexity as indicated by the at least one first syntax element; and reconstructing the bitstream based on the values of the at least one first and at least one second syntax element. The at least one first syntax element contains at least one of a profile, tier, or level.

Some aspects of the disclosure also provide techniques for encoding a video bitstream by a cooperative encoder. In an example, the techniques include selecting, among coding tools and options available under a set of restrictions as represented by values of at least one first syntax element, a subset of such coding tools and options so that the decoding complexity is lower than the worst-case decoder complexity under the set of restrictions represented by the at least one first syntax element; and encoding at least one picture into a video bitstream using the subset of coding tools and options. The bitstream includes at least the first at least one syntax element, the second at least one syntax element, and the at least one encoded picture; wherein the at least one first syntax element contains at least one of a profile, tier, or level.

Some aspects of the disclosure also provide bitstreams decodable by a decoder including at least a first and a second syntax element, and a coded picture. The first syntax element comprises at least one of a profile, tier, or level; the second syntax element includes a complexity indication structure. The complexity indication structure includes at least one syntax element indicative of the bitstream observing a restricting from worst-case complexity.

In an aspect, video encoding and decoding can use inter-picture prediction with motion compensation. Uncompressed digital video can consist of a series of pictures, each picture having a spatial dimension of, for example, 1920 x 1080 luminance samples and associated chrominance samples. The series of pictures can have a fixed or variable picture rate (informally also known as frame rate), of, for example 60 pictures per second or 60 Hz. Uncompressed video can have significant bitrate requirements. For example, 1080p60 4:2:0 video at 8 bit per sample (1920x1080 luminance sample resolution at 60 Hz frame rate) requires close to 1.5 Gbit/s bandwidth. In an example, an hour of such video requires more than 600 GByte of storage space.

According to some aspects, one purpose of video coding and decoding can be the reduction of redundancy in the input video signal, through compression. Compression can help reducing aforementioned bandwidth or storage space requirements, in some cases by two orders of magnitude or more. Both lossless and lossy compression, as well as a combination thereof can be employed. Lossless compression refers to techniques where an exact copy of the original signal can be reconstructed from the compressed original signal. When using lossy compression, the reconstructed signal may not be identical to the original signal, but the distortion between original and reconstructed signal is small enough to make the reconstructed signal useful for the intended application. In the case of video, lossy compression is widely employed. The amount of distortion tolerated depends on the application; for example, users of certain consumer streaming applications may tolerate higher distortion than users of television contribution applications. The compression ratio achievable can reflect that: higher allowable/tolerable distortion can yield higher compression ratios.

In various examples, a video encoder and decoder can utilize techniques from several broad categories, including, for example, motion compensation, transform, quantization, and entropy coding, some of which will be introduced below.

According to some aspects, scalable video coding involves the coding of the video signal in multiple bitstreams known as layers.

In some aspects, video coding and compression, and inverse operations (e.g., decoding and decompression), can have computational complexity constraints that can be challenging. In an aspect, over the past decades, coding video at resolutions appropriate for the markets—which have increased over time—and using then modern video coding standards—whose complexity per pixel to be coded has also increased over time—has outpaced the advances of CPU design. Many devices can rely on specialized hardware to accelerate encoding and decoding of coded video. In an example, the reference software ECM, currently in use by the Joint Video Team (JVT) is so complex that encoding a single picture of a video sequence can take hours, on a reasonable fast CPU core.

According to some aspects of the disclosure, the lifecycle of consumer devices, such as smartphones, has increased in duration. Only a few years ago, a large percentage of the smartphone population in the US was refreshed on a one year or two year schedule, as (among other reasons) advances in their technical design made upgrades appealing to the consumer. Now, even some technology savvy individuals keep their smartphones for three or more years. Similar trends are observable for smart TVs and other video capable devices.

As a result, a slowing of the increase in the capabilities, on average, in the endpoint population can be observed, making the adoption of new, high complexity video coding technologies more difficult. Techniques are therefore needed that allow the video bitstream to scale in complexity, in that a low complexity bitstream can provide sufficient, but not necessarily particularly good quality, whereas a higher complexity bitstream, after decoding would look visually better—so much better to be part of the technical incentives that make a consumer upgrade their device.

In some aspects, scalability has long been the technology of choice to make a video bitstream adaptable to outside requirements. However, the traditional scalability modalities, such as temporal, spatial, and SNR scalability, as described in more detail below, do not offer a mechanism to allow for a sufficiently large and—more importantly—guaranteed maximum complexity requirement per layer. In an aspect, temporal scalability allows only to increase the frame rate, and the maximum complexity changes approximately linear with the frame rate. In another aspect, SNR scalability’s complexity changes also linearly with the number of SNR scalable layers, where two layers double the complexity, three layers triple it, and so forth. In some examples, the coding technique of SNR scalability are the same among all layers. In another aspect, spatial scalability’s performance requirements depend on the pixel count and can make a significant impact on complexity. However, in some examples, given the small size of, for example, smartphone displays, it can hardly be seen how an increase from, for example 1080p to 4k resolution makes a significant impact on the user experience.

In some aspects, a scalability dimension may be needed that goes beyond temporal, SNR, and spatial scalability that addresses complexity, for example at a given resolution (similar to SNR scalability) but with potentially orders of magnitude complexity differences, per layer, such as in both encoder and decoder.

Further, in an aspect, some system environments may not be particularly well suited to support scalability. In such system environments, a single layer solution to manage complexity can work. In that regard, some existing video coding standards are designed such that a decoder needs to be capable of decoding any bitstream compliant with a given profile, tier, and level, including bitstreams specifically designed to exercise maximum complexity or memory consumption “pain points” in a codec design. In an example, the bitstreams designed to excise maximum complexity or memory consumption “pain points” are known as evil bitstreams. Limiting the decoding complexity by making sensible choices of coding modes in the encoder, can be one option to allow the decoding of bitstream by a decoder that would not normally be able to assert compliance with a given profile, tier, or level. Using such restrictions is known as cooperative encoding. However, to be useful in a standards setting, encoder and decoder may agree on cooperative encoding and, in standardized environments, signaling can be devised that allows for cooperative encoding.

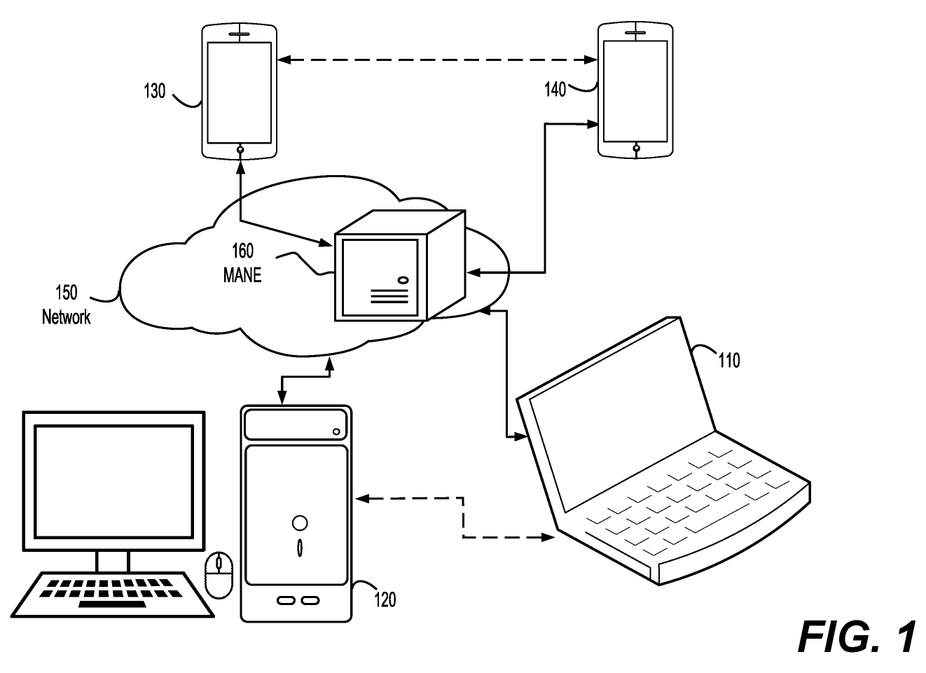

FIG. 1 shows a block diagram of a communication system (100) according to an aspect of the present disclosure. The communication system (100) can include a plurality of terminal devices, such as a first terminal device (110), a second terminal device (120), a third terminal device (130), a fourth terminal device (140) that are interconnected via a network (150). In an example, for unidirectional transmission of data, the first terminal device (110) can code video data at a local location for transmission to the second terminal device (120) via the network (150). The second terminal device (120) can receive the coded video data of the first terminal device (110) from the network (150), decode the coded data and display the recovered video data. Unidirectional data transmission can be used in media serving applications and the like.

In the FIG. 1 example, the third terminal device (130) and the fourth terminal device (140) are configured to support bidirectional transmission of coded video that can occur, for example, during videoconferencing. For bidirectional transmission of data, each of the third terminal device (130) and the fourth terminal device (140) can code video data captured at a local location for transmission to the other terminal device via the network (150). each of the third terminal device (130) and the fourth terminal device (140) also can receive the coded video data transmitted by the other terminal, can decode the coded data and can display the recovered video data at a local display device.

It is noted that the terminal devices (110), (120), (130), and (140) can be any of servers, personal computers, smart phones, and the like, and are not limited to what are shown in the FIG. 1 example. Techniques disclosure in the present disclosure can find application with laptop computers, tablet computers, media players and/or dedicated video conferencing equipment. The network (150) can represent any number of networks that convey coded video data among the terminal devices (110), (120), (130), and (140), including for example wireline and/or wireless communication networks. The network (150) can exchange data in circuit-switched and/or packet-switched channels. Representative networks include telecommunications networks, local area networks, wide area networks and/or the Internet. For the purposes of the present discussion, the architecture and topology of the network (150) may be immaterial to the operation of the present disclosure unless explained herein below. The network (150) can include Media Aware Network Elements (MANEs, 160) that may be included in the transmission path between, for example, the third terminal device (130) and the fourth terminal device (140). The MANE (160) can selectively forward parts of the media data to react to network congestions, media switching, media mixing, archival, and similar tasks commonly performed by a service provider rather than an end user. Such MANEs may be able to parse and react on a limited part of the media conveyed over the network, for example syntax elements related to the network abstraction layer of video coding technologies or standards.

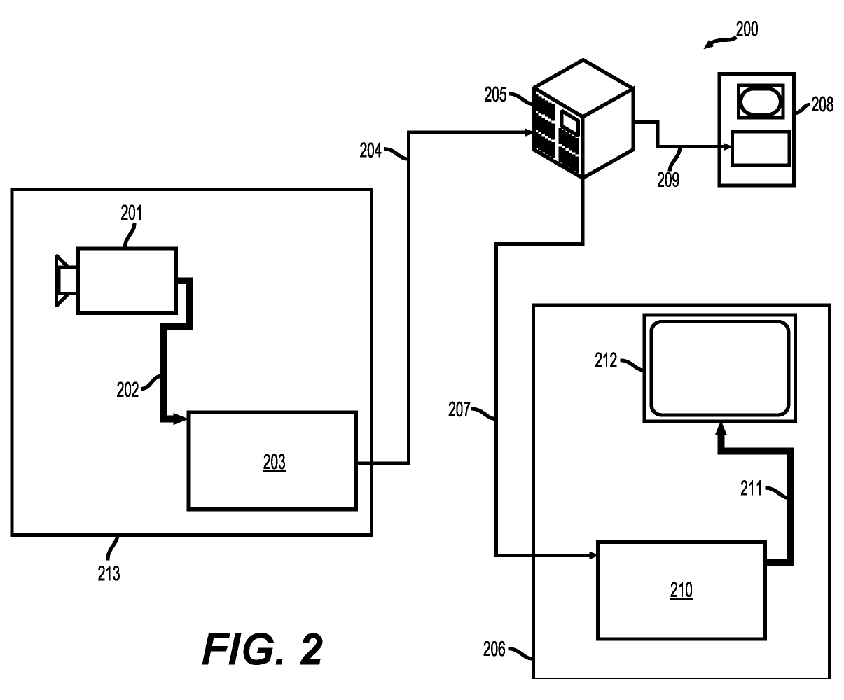

FIG. 2 shows an example for an application a video encoder and decoder in a streaming environment according to some aspects of the disclosure. It is noted that the disclosed subject matter in FIG. 2 can be suitably applicable to other video enabled applications, including, for example, video conferencing, digital TV, storing of compressed video on digital media including CD, DVD, memory stick and the like, and so on.

In the FIG. 2 example, a streaming system (200) includes a capture subsystem (213), that can include a video source (201), for example a digital camera, creating, for example, an uncompressed video sample stream (202). The uncompressed video sample stream (202), depicted as a bold line to emphasize a high data volume when compared to encoded video bitstreams, can be processed by an encoder (203) coupled to the camera (201). The encoder (203) can include hardware, software, or a combination thereof to enable or implement aspects of the disclosed subject matter as described in more detail below. The encoded video bitstream (204), depicted as a thin line to emphasize the lower data volume when compared to the uncompressed video sample stream (202), can be stored on a streaming server (205) for future use. One or more streaming client devices (206) and (208) can access the streaming server (205) to retrieve copies (207) and (209) of the encoded video bitstream (204). The client device (206) can include a video decoder (210) which decodes the incoming copy of the encoded video bitstream (207) and creates an outgoing video sample stream (211) that can be rendered on a display (212) or other rendering device (not depicted). In some streaming systems, the video bitstreams (204), (207), and (209) can be encoded according to certain video coding/compression standards. Examples of those standards include ITU-T Recommendations H.265 and H.266. The disclosed subject matter can be used in the context of VVC.

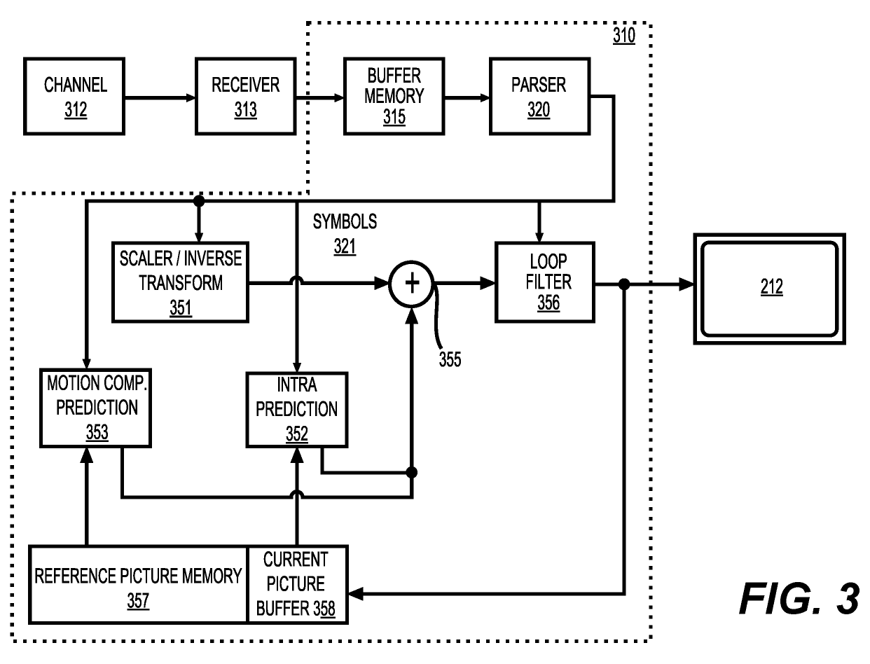

FIG. 3 shows a block diagram of a video decoder (310) according to an aspect of the present disclosure. The video decoder (310) can be used as the video decoder (210) in FIG. 2.

In the FIG. 3 example, a receiver (313) may receive one or more coded video sequences to be decoded by the video decoder (310). In some examples, one coded video sequence is decoded at a time, where the decoding of each coded video sequence is independent from other coded video sequences. In the FIG. 3 example, the coded video sequence is received from a channel (312), which may be a hardware/software link to a storage device which stores the encoded video data. The receiver (313) may receive the encoded video data with other data, for example, coded audio data and/or ancillary data streams, that may be forwarded to their respective using entities (not depicted). The receiver (313) may separate the coded video sequence from the other data. In the FIG. 3 example, to combat network jitter, a buffer memory (315) is coupled in between the receiver (313) and an entropy decoder / parser (320) (“parser” henceforth). When the receiver (313) is receiving data from a store/forward device of sufficient bandwidth and controllability, or from an isosychronous network, the buffer memory (315) may not be needed, or can be small. For use on best effort packet networks such as the Internet, the buffer memory (315) may be required, can be comparatively large and can advantageously of adaptive size.

In the FIG. 3 example, the video decoder (310) may include the parser (320) to reconstruct symbols (321) from the entropy coded video sequence. Categories of the symbols (321) include information used to manage operation of the video decoder (310), and potentially information to control a rendering device, such as the display (212) that is not an integral part of the video decoder (310) but can be coupled to the video decoder (310). In some examples, the control information for the rendering device(s) can be in the form of supplementary enhancement information (SEI messages) or video usability information (VUI) parameter set fragments (not depicted). The parser (320) can parse / entropy-decode the coded video sequence received. The coding of the coded video sequence can be in accordance with a video coding technology or standard, and can follow principles, including variable length coding, Huffman coding, arithmetic coding with or without context sensitivity, and so forth. The parser (320) can extract from the coded video sequence, a set of subgroup parameters for at least one of the subgroups of pixels in the video decoder, based upon at least one parameters corresponding to the group. Subgroups can include groups of pictures (GOPs), pictures, tiles, slices, macroblocks, coding units (CUs), blocks, transform units (TUs), prediction units (PUs) and so forth. The parser (320) can also extract from the coded video sequence information such as transform coefficients, quantizer parameter values, motion vectors, and so forth.

The parser (320) can perform entropy decoding / parsing operation on the coded video sequence received from the buffer (315), so to create the symbols (321).

In some aspects, reconstruction of the symbols (321) can involve multiple different units depending on the type of the coded video picture or parts thereof (such as: inter and intra picture, inter and intra block), and other factors. Which units are involved, and how, can be controlled by the subgroup control information that was parsed from the coded video sequence by the parser (320). The flow of such subgroup control information between the parser (320) and the multiple units below is not depicted for clarity.

Beyond the functional blocks already mentioned, the video decoder 310 can be conceptually subdivided into a number of functional units as described below. In an implementation operating under commercial constraints, many of these units can interact closely with each other and can, at least partly, be integrated into each other. However, for the purpose of describing the disclosed subject matter, the conceptual subdivision into the functional units below is appropriate.

In the FIG. 3 example, the video decoder (310) includes a scaler / inverse transform unit (351). The scaler / inverse transform unit (351) receives quantized transform coefficient as well as control information, including which transform to use, block size, quantization factor, quantization scaling matrices, etc. as the symbols (321) from the parser (320). The scaler / inverse transform unit (351) can output blocks including sample values, that can be input into an aggregator (355).

In some cases, the output samples of the scaler / inverse transform (351) can pertain to an intra coded block; that is: a block that is not using predictive information from previously reconstructed pictures, but can use predictive information from previously reconstructed parts of the current picture. Such predictive information can be provided by an intra picture prediction unit (352). In some cases, the intra picture prediction unit (352) generates a block of the same size and shape of the block under reconstruction, using surrounding already reconstructed information fetched from the current (partly reconstructed) picture in a current picture buffer (358). The aggregator (355), in some cases, adds, on a per sample basis, the prediction information that is generated by the intra prediction unit (352) with the output sample information as provided by the scaler / inverse transform unit (351).

In other cases, the output samples of the scaler / inverse transform unit (351) can pertain to an inter coded, and potentially motion compensated block. In such a case, a motion compensation prediction unit (353) can access a reference picture memory (357) to fetch samples used for prediction. After motion compensating the fetched samples in accordance with the symbols (321) pertaining to the block, these samples can be added by the aggregator (355) to the output of the scaler / inverse transform unit (351) (in this case called the residual samples or residual signal) so to generate output sample information. The addresses within the reference picture memory (357) from where the motion compensation unit fetches prediction samples can be controlled by motion vectors, available to the motion compensation unit (353) in the form of symbols (321) that can have, for example X, Y, and reference picture components. Motion compensation also can include interpolation of sample values as fetched from the reference picture memory (357) when sub-sample exact motion vectors are in use, motion vector prediction mechanisms, and so forth.

The output samples of the aggregator (355) can be subject to various loop filtering techniques in a loop filter unit (356). Video compression technologies can include in-loop filter technologies that are controlled by parameters included in the coded video bitstream and made available to the loop filter unit (356) as symbols (321) from the parser (320), but can also be responsive to meta-information obtained during the decoding of previous (in decoding order) parts of the coded picture or coded video sequence, as well as responsive to previously reconstructed and loop-filtered sample values.

The output of the loop filter unit (356) can be a sample stream that can be output to a render device, such as the display (212), as well as stored in the reference picture memory (357) for use in future inter-picture prediction.

Certain coded pictures, once fully reconstructed, can be used as reference pictures for future prediction. Once a coded picture is fully reconstructed and the coded picture has been identified as a reference picture (by, for example, parser (320)), the current picture buffer (358) can become a part of the reference picture memory (357), and a fresh current picture memory can be reallocated before commencing the reconstruction of the following coded picture.

It is noted that the video decoder (310) can perform decoding operations according to a predetermined video compression technology that may be documented in a standard, such as ITU-T Rec. H.266. The coded video sequence can conform to a syntax specified by the video compression technology or standard being used, in the sense that it adheres to the syntax of the video compression technology or standard, as specified in the video compression technology document or standard and specifically in the profiles document therein.

In some examples, compliance can also include that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through hypothetical reference decoder (HRD) specifications and metadata for HRD buffer management signaled in the coded video sequence.

In some aspects, the receiver (313) can receive additional (redundant) data with the encoded video. The additional data may be included as part of the coded video sequence(s). The additional data may be used by the video decoder (310) to properly decode the data and/or to more accurately reconstruct the original video data. Additional data can be in the form of, for example, temporal, spatial, or SNR enhancement layers, redundant slices, redundant pictures, forward error correction codes, and so on.

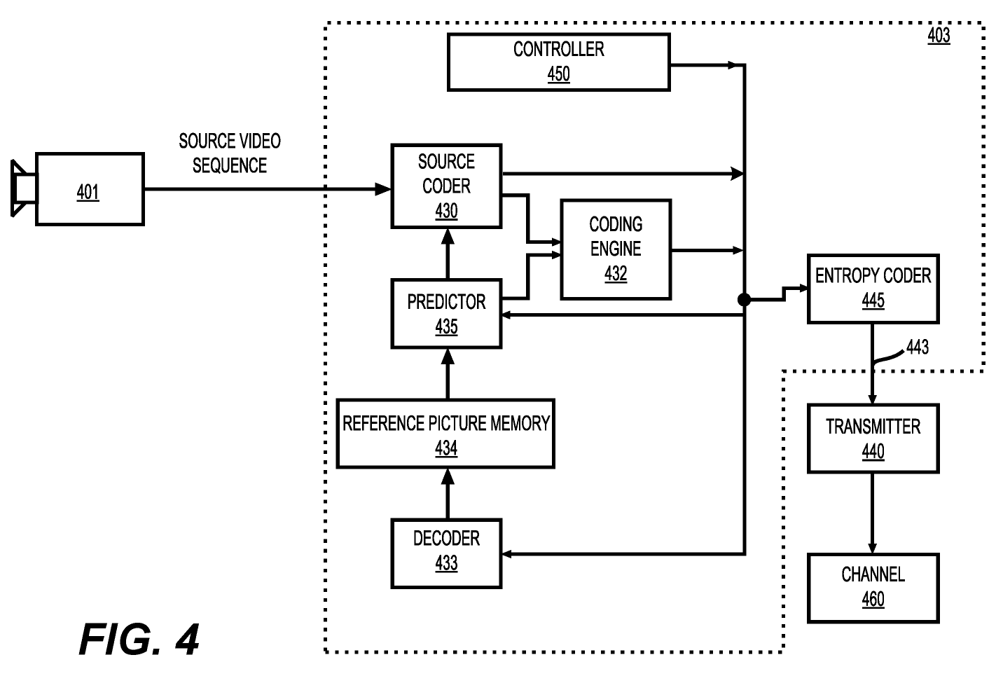

FIG. 4 shows a block diagram of a video encoder (403), that can be used to implement the video encoder (203), according to some aspects of the present disclosure.

In the FIG. 4 example, the video encoder (403) can receive video samples from a video source (401) (e.g., not a part of the video encoder (401)) that may capture video image(s) to be coded by the video encoder (403).

In some examples, the video source (401) can provide the source video sequence to be coded by the video encoder (403) in the form of a digital video sample stream that can have any suitable bit depth (for example: 8 bit, 10 bit, 12 bit, …), any colorspace (for example, BT.601 Y CrCB, RGB, …) and any suitable sampling structure (for example Y CrCb 4:2:0, Y CrCb 4:4:4). In an example of a media serving system, the video source (401) can be a storage device storing previously prepared video. In an example of a videoconferencing system, the video source (403) can be a camera that captures local image information as a video sequence. Video data can be provided as a plurality of individual pictures that impart motion when viewed in sequence. The pictures themselves can be organized as a spatial array of pixels, and each pixel can include one or more samples depending on the sampling structure, color space, etc. in use. The description below focusses on samples.

According to some aspects, the video encoder (403) can encode and compress the pictures of a source video sequence into a coded video sequence (443) in real time or under any other time constraints as required by an application. In an example, a controller (450) is configured to perform a function for enforcing appropriate coding speed. The controller (450) can control other functional units as described below and is functionally coupled to the functional units. The coupling is not depicted for clarity. Parameters set by the controller (450) can include rate control related parameters (e.g., picture skip, quantizer, lambda value of rate-distortion optimization techniques, …), picture size, group of pictures (GOP) layout, maximum motion vector search range, and so forth. It is noted that the controller (450) can include other suitable functions pertain to video encoder (403) optimized for a certain system design.

According to some aspects of the disclosure, video encoders can operate in a “coding loop”. As an oversimplified description, a coding loop can include an encoding part that is referred to as a source coder (430) (responsible for creating symbols based on an input picture to be coded, and a reference picture(s)), and a local video decoder (433) embedded in the video encoder (403) that reconstructs the symbols to create the sample data that a (remote) decoder also would create (as any compression between symbols and coded video bitstream is lossless in the video compression technologies considered in the disclosed subject matter). That reconstructed sample stream is input to the reference picture memory (434). As the decoding of a symbol stream leads to bit-exact results independent of decoder location (local or remote), the content buffered in the reference picture memory (434) is also bit exact between the local decoder and the remote decoder. In other words, the prediction part of an encoder “sees” as reference picture samples exactly the same sample values as a decoder would “see” when using prediction during decoding. The bit-exact results between the local decoder and the remote decoder can be referred to reference picture synchronicity (and resulting drift, when synchronicity cannot be maintained, for example because of channel errors).

The operations of the local video decoder (433) can be the same as of a “remote” video decoder, such as the video decoder (310) that has been described in detail above in conjunction with FIG. 3. Briefly referring also to FIG. 3, in some examples, as symbols are available and encoding/decoding of symbols to a coded video sequence can be lossless, the entropy decoding parts of video decoder (310), for example including the channel (312), the receiver (313), the buffer memory (315), and the parser (320) may not be fully implemented in the local video decoder (433).

In some aspects, the decoder technology (except the parsing/entropy decoding) that is implemented in a decoder can be implemented in substantially identical functional form, in a corresponding encoder. In an aspect, while the disclosed subject matter in the present disclosure may focus on decoder operation, the description of encoder technologies can be abbreviated as they are the inverse of the comprehensively described decoder technologies. Some encoding areas are provided below in more detail description.

In some aspects, the source coder (430) can perform motion compensated predictive coding, which codes an input frame predictively with reference to one or more previously-coded frames from the video sequence, the one or more previously coded frames are designated as “reference frames.” In some examples, a coding engine (432) can code differences between pixel blocks of an input frame and pixel blocks of reference frame(s) that may be selected as prediction reference(s) to the input frame.

Further, the local video decoder (433) can decode the coded video data of frames that are designated as reference frames, based on symbols created by the source coder (430). In some examples, operations of the coding engine (432) can be lossy processes. When the coded video data is decoded at a video decoder (e.g., a remote video decoder not shown in FIG. 4), the reconstructed video sequence typically may be a replica of the source video sequence with some errors. The local video decoder (433) can replicate decoding processes that may be performed by the remote video decoder on reference frames and can cause reconstructed reference frames to be stored in the reference picture cache (434) (also referred to as reference picture memory). In this manner, the video encoder (403) can store copies of reconstructed reference frames locally that have common content as the reconstructed reference frames that will be obtained by a far-end (remote) video decoder (absent transmission errors).

In some aspects, a predictor (435) can perform prediction searches for the coding engine (432). For example, for a new frame to be coded, the predictor (435) can search the reference picture memory (434) for sample data (as candidate reference pixel blocks) or certain metadata, such as reference picture motion vectors, block shapes, and so on, that can serve as an appropriate prediction reference for the new frame. The predictor (435) can operate on a block basis to find appropriate prediction references. In some cases, as determined by search results obtained by the predictor (435), an input picture may have prediction references drawn from multiple reference pictures stored in the reference picture memory (434).

In the FIG. 4 example, the controller (450) can manage coding operations of the video encoder (403), including, for example, setting of parameters and subgroup parameters used for encoding the video data.

In an aspect, output of all aforementioned functional units can be subjected to entropy coding in the entropy coder (445). The entropy coder translates the symbols as generated by the various functional units into a coded video sequence, by loss-less compressing that compresses the symbols according to various technologies, for example Huffman coding, variable length coding, arithmetic coding, and so forth.

In the FIG. 4 example, the transmitter (440) can buffer the coded video sequence(s) as created by the entropy coder (445) to prepare for transmission via a communication channel (460), which may be a hardware/software link to a storage device that can store the encoded video data. The transmitter (440) can merge coded video data from the video encoder (403) with other data to be transmitted, for example, coded audio data and/or ancillary data streams (sources not shown).

In the FIG. 4 example, the controller (450) can manage operation of the video encoder (403). For example, during coding, the controller (450) can assign to each coded picture a certain coded picture type, which may affect the coding techniques that is applied to the respective picture. For example, pictures often are assigned as one of the following frame types: an intra picture (I picture), a predictive picture (P picture) and a bi-directionally predictive picture (B picture).

In some aspects, an intra picture (I picture) is one that may be coded and decoded without using any other frame in the sequence as a source of prediction. Some video codecs allow for different types of intra pictures, including, for example independent decoder refresh pictures. It is noted that there can be variants of I pictures for some applications and features.

In some aspects, a predictive picture (P picture) is one that may be coded and decoded using intra prediction or inter prediction using at most one motion vector and reference index to predict the sample values of each block.

In some aspects, a bi-directionally predictive picture (B picture) may be one that may be coded and decoded using intra prediction or inter prediction using at most two motion vectors and reference indices to predict the sample values of each block. Similarly, multiple-predictive pictures can use more than two reference pictures and associated metadata for the reconstruction of a single block.

In some aspects, source pictures may be subdivided spatially into a plurality of sample blocks (for example, blocks of 4x4, 8x8, 4x8, or 16x16 samples each) and coded on a block-by-block basis. Blocks may be coded predictively with reference to other (already coded) blocks as determined by the coding assignment applied to the blocks’ respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

In an aspect, the video encoder (403) can perform coding operations according to a predetermined video coding technology or standard, such as ITU-T Rec. H.266. In the operations, the video encoder (403) may perform various compression operations, including predictive coding operations that exploit temporal and spatial redundancies in the input video sequence. The coded video data, therefore, may conform to a syntax specified by the video coding technology or standard being used.

In some examples, the transmitter (440) can transmit additional data with the encoded video. The video encoder (403) can include such data as part of the coded video sequence. Additional data may comprise temporal/spatial/SNR enhancement layers, other forms of redundant data such as redundant pictures and slices, supplementary enhancement information (SEI) messages, visual usability information (VUI) parameter set fragments, and so on.

In some aspects, compressed video can be augmented, in the video bitstream, by supplementary enhancement information, for example in the form of supplementary enhancement information (SEI) messages or video usability information (VUI). Video coding standards can include specifications parts for SEI and VUI. SEI and VUI information may also be specified in stand-alone specifications that may be referenced by the video coding specifications.

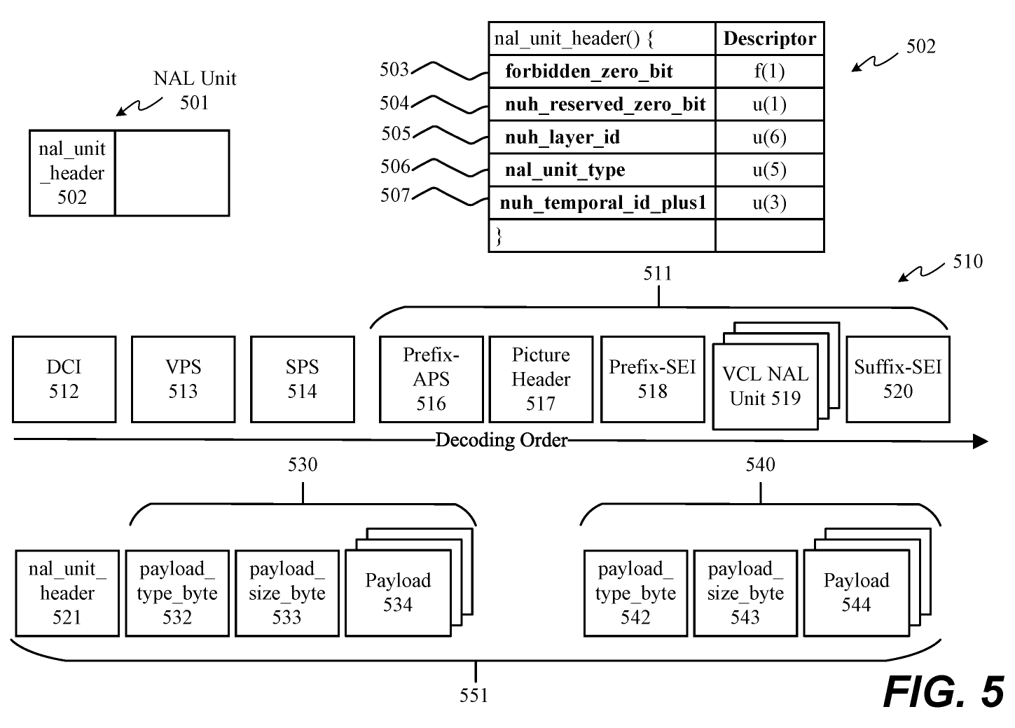

FIG. 5 shows a layout of a coded video sequence (CVS) according to a video coding standard, such as H.266, in some examples. The coded video sequence is subdivided into network abstraction layer units (NAL units). In FIG. 5, an NAL unit (501) can include a NAL unit header (502), which in turn includes 16 bits. For example, the NAL unit header (502) includes a forbidden_zero_bit (503) and a nuh_reserved_zero_bit (504) that may be unused by H.266 and may be zero in a NAL unit compliant with H.266. In the FIG. 5 example, the NAL unit header (502) includes six bits of nuh_layer_id (505) that may be indicative of a layer (e.g., a spatial layer, an SNR enhancement layer, or a multiview enhancement layer) to which the NAL unit belongs. The NAL unit header (502) also includes five bits of nal_unit_type that define the type of the NAL unit. The five bits of nal_unit_type can have 32 values. For example, in H.266 (04/2022), 22 values are defined for NAL unit types that are used in H.266, six values are reserved for additional NAL unit types, and four values are unspecified and can be used by specifications other than H.266. Finally, the NAL unit header (502) includes three bits of nuh_temporal_id_plus1 (506) that indicate the temporal layer to which the NAL unit belongs.

According to some aspects, a coded picture can include one or more video coding layer (VCL) NAL units and zero or more non-VCL NAL units. VCL NAL units can include coded data conceptually belonging to a video coding layer. Non-VCL NAL units can include data conceptually belonging, data not conceptually belonging to the video coding layer.

In an example according to H.266, the non-VCL NAL units can be categorized into following six categories.

(1) Parameter sets, which include information that can be necessary for the decoding process and can apply to more than one coded picture. Parameter sets and conceptually similar NAL units may be of NAL unit types, such as DCI_NUT (decoding capability information (DCI)), VPS_NUT (video parameter set (VPS), establishing, among other things, layer relationships), SPS_NUT (Sequence Parameter Set (SPS), establishing, among other things, parameters used and staying constant throughout a coded video sequence CVS), PPS_NUT (picture parameter set (PPS), establishing, among other things, parameter used and staying constant within a coded picture), and PREFIX_APS_NUT and SUFFIX_APS_NUT (prefix and suffix adaptation parameter sets). Parameter sets may include information required for a decoder to decode VCL NAL units, and hence are referred here as “normative” NAL units.

(2) Picture header (PH_NUT), which is also a “normative” NAL unit.

(3) NAL units marking certain places in a NAL unit stream. Those include NAL units with the NAL unit types AUD_NUT (access unit delimiter), EOS_NUT (end of sequence) and EOB_NUT (end of bitstream). These are non-normative, also known as informative, in the sense that a compliant decoder does not require them for its decoding process, although it needs to be able to receive them in the NAL unit stream.

(4) Prefix and suffix SEI NAL unit types (PREFIX_SEI_NUT and SUFFIX_SEI_NUT) which indicate NAL units containing prefix and suffix supplementary enhancement information. In some examples according to H.266 (04/2022), those NAL units are informative, as they are not required for the decoding process.

(5) Filler data NAL unit type FD_NUT indicates filler data; data that can be random and can be used to “waste” bits in a NAL unit stream or bitstream, which may be necessary for the transport over certain isochronous transport environments.

(6) Reserved and Unspecified NAL unit types.

FIG. 5 also shows a layout of a NAL unit stream (510) in a decoding order in some examples. The NAL unit stream (510) includes a coded picture (511). The NAL unit stream (510) includes DCI (512), VPS (513), and SPS (514), (somewhere) earlier than the coded picture (511). DCI (512), VPS (513), and SPS (514) may, in combination, establish the parameters which the decoder can use to decode the coded pictures of a coded video sequence (CVS), including the coded picture (511) in the NAL unit stream (510).

In the FIG. 5 example, the coded picture (511) can include, in the depicted order or any other order compliant with the video coding technology or standard in use (such as H.266 in the present disclosure): a prefix APS (516), picture header (PH, 517), prefix SEI (518), one or more VCL NAL units (519), and suffix SEI (520).

In some examples, prefix and suffix SEI NAL units (518) and (520) are configured during the standards development as, for some SEI messages, the content of the message would be known before the coding of a given picture commences, whereas other content would only be known once the picture were coded. Allowing certain SEI messages to appear early or late in a coded picture’s NAL unit stream through prefix and suffix SEIs allows avoiding buffering. For example, in an encoder, the sampling time of a picture to be coded is known before the picture is coded, and hence the picture timing SEI message can be a prefix SEI message (518). On the other hand, a decoded picture hash SEI message, which contains a hash of the sample values of a decoded pictures and can be useful, for example, to debug encoder implementations, is a suffix SEI message (520) as an encoder cannot calculate a hash over reconstructed samples before a picture has been coded. The location of prefix and suffix SEI NAL units may not be restricted to their position in the NAL unit stream. The phrase “prefix” and “suffix” may imply to what coded pictures or NAL units the prefix/suffix SEI message may pertain to, and the details of this applicability may be specified, for example in the semantics description of a given SEI message.

FIG. 5 also shows a syntax diagram of a NAL unit (551) that contains a prefix or suffix SEI message. The syntax diagram can be a container format for multiple SEI messages that can be carried in one NAL unit (also referred to as SEI NAL unit). Details of the emulation prevention syntax specified in H.266 are omitted here for clarity. As other NAL units, an SEI NAL unit starts with a NAL unit header (521). The NAL unit header (521) is followed by one or more SEI messages, such as a first SEI message (530) and a second SEI message (540) in FIG. 5. Each SEI message inside the NAL unit (551) includes an 8 bit payload_type_byte which specifies one of 256 different SEI types, such as shown by payload_type_byte (532) and payload_type_byte (542) in FIG. 5. Further, each SEI message inside the NAL unit (551) includes an 8bit payload_size_byte which specifies the number of bytes of the SEI payload (e.g., the byte number of the payload minus 1), such as shown by payload_size_byte (533) and payload_size_byte (543) in FIG. 5. Then, each SEI message inside the NAL unit (551) includes SEI payload with the number of bytes specified by payload_size_byte, such as the payload (534) and the payload (544). The syntax of the payload (534) and the payload (544) can depend on the SEI message. In some examples, the payload (e.g., the payload (534), the payload (544)) can be of any length between 0 and 254 bytes unless an extension mechanism is used (not shown), in which case the syntax can allow for unlimited payload sizes.

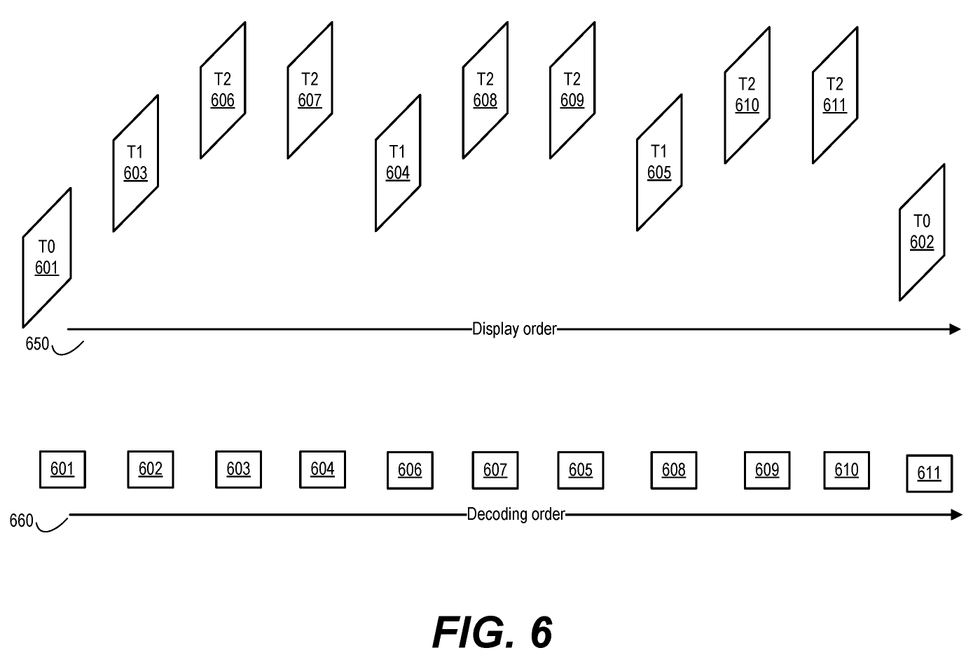

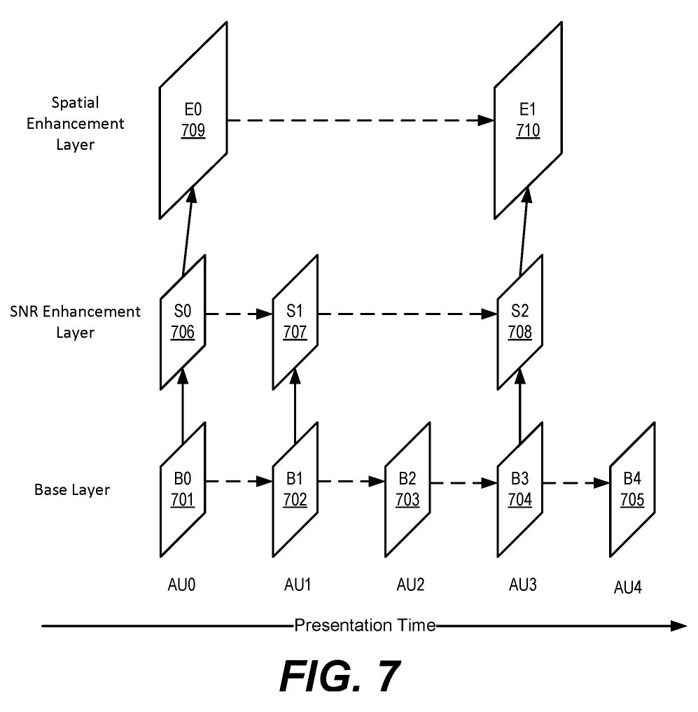

FIG. 6 and FIG. 7 show diagrams of scalability examples that are employed by some video codecs. Whether a certain scalability type is supported by encoder or decoder depends on the video coding standard or technology, implementation, and may also depend on the profile or similar mechanisms that may be able to reduce the full functionality of a video coding specification.

In some aspects, scalability can be based on the concept of a coded video sequence (CVS) that includes more than one coded layer video sequence (CLVS), which is known as a layer. In some examples, a (compliant) coded video sequence includes at least one coded layer video sequence, which is informally known as a base layer. One or more additional coded layer video sequences can be included in the coded video sequence. Depending on the profile used, the one or more additional coded layer video sequences are informally called layers (in case of layered coding) or views (in case of multiview coding). In some aspects, temporally, a coded video sequence (CVS) is divided into access units (AUs). Each access unit includes one or more coded pictures, each belonging to a layer. When and how one or more coded pictures in an access unit are decoded and how they are combined can be specified by the video coding standard or specification.

FIG. 6 shows a diagram for a temporal scalability in some examples. The temporal scalability is a scalability type that can operate with a single coded picture in an access unit. When the temporal scalability is employed, certain coded pictures (e.g., second pictures) are coded in a manner that they are not required to reconstruct other pictures (e.g., first pictures). Accordingly, those pictures (e.g., second pictures) may be removed from the CVS, or the decoder may choose not to decode them (second pictures), with no negative impact on reproduced video quality but can cause a reduction in frame rate in some examples.

For historic reasons, many existing video codec standards or specifications refer to coded pictures associated with a temporal layer as a sublayer, and that convention is used herein as well.

In some examples, temporal scalability can have a (temporal) base layer, that may be defined as a set of coded pictures that have dependencies only to other pictures in the base layer. FIG. 6 shows a temporal base layer that includes pictures (601) and (602). The pictures (601) and (602) depend only on each other, and not on any other depicted picture (e.g., of enhancement layers) in FIG. 6 example. In the FIG. 6 example, the temporal base layer is denoted by T0 that is labeled on the pictures (601) and (602).

FIG. 6 also shows sublayers T1 and T2. For example, the sublayer T1 includes pictures (603)-(605), and the sublayer T2 includes the pictures (606)-(611). The pictures (603)-(611) are also referred to as sublayer pictures. Each sublayer picture can refer to pictures within a same sublayer, or to lower sublayer pictures (including the temporal base layer) for prediction.

In some examples, the prediction structure can have nested nature. A video codec standard or technology may disallow, or allow for, or require, signaling of prediction relationships that cross the nested nature of the prediction structure. In some examples, restrictions may be applied to the prediction relationship. In an example, the picture (610) is not predicted from picture (609), despite the picture (609) being in the same sublayer as the picture (610); nor is the picture (610) predicted from the picture (604) of the sublayer T1. The restrictions to a fully-nested prediction structure, in many cases, can simplify the description of scalability features and is henceforth assumed unless stated otherwise. However, such simplification and omittance of possible distracting complexity is not meant to limit the scope of the disclosed subject matter to fully nested coded video sequences (CVSs) or coded layer video sequences (CLVSs); the techniques disclosed herein can equally be employed on not fully-nested scenarios and fully-nested scenarios.

In the FIG. 6 example, the pictures (601)-(611) are shown in an order of presentation sequence (e.g., display order (650)) which, assuming a fixed capture frame rate, may be equivalent to presentation time. FIG. 6 also shows a decoding order (660) that is a sensible bitstream order that can minimize buffering memory as well as delay. In some examples, for a given picture, the decoder may have pictures required for prediction of the given picture reconstructed before attempting the reconstruction of the given picture—otherwise, information required for prediction may not be available. In some video coding standards and technology, this requirement dictates the order of coded pictures in a coded video sequence (CVS) (and coded layer video sequences (CLVSs)), which may be expressed as a bitstream structure constraint. Certain system specifications mandate one or more defined prediction structures, and certain video codec specifications include metadata-based mechanisms that announce the prediction structure the encoder is using. Either or both can be employed to facilitate the detection of coded pictures that are required for reconstruction, for example through packet loss. An error resilient decoder can react to such information, for example, by omitting the decoding of the remainder of the pictures of the affected sublayer and all higher sublayers.

FIG. 7 shows an example of a prediction structure using temporal, spatial, and SNR layers according to an aspect of the disclosure. The prediction structure includes coded pictures B0-B4, S0-S2 and E0-E1. In the FIG. 7 example, a base layer includes five pictures B0 (701) to B4 (705) (also referred to as base layer pictures), an SNR enhancement layer includes three pictures S0 (706) to S2 (708) (also referred to as SNR enhancement layer pictures), and a spatial enhancement layer includes two pictures E0 (709) and E1 (710) (also referred to as spatial enhancement layer pictures). The five base layer pictures B0 (701) to B4 (705) are respectively in five access units (AUs), such as shown by AU0 to AU4 in FIG. 7. For example, a first access unit AU0 includes the base layer picture B0 (701), the SNR enhancement layer picture S0 (706) that is inter-layer predicted from the base layer picture B0 (701), and the spatial enhancement layer picture E0 (709) that is predicted from the SNR enhancement layer picture S0 (706). The coded picture B0 (701), S0 (706), and E0 (709) share the same presentation time and are in the same access unit.

In the FIG. 7 example, inter-layer predictions are shown by straight arrows, temporal predictions are shown by dashed arrows. For example, the picture B1 (702) is temporally predicted from B0 (701), and B2 (703) is temporally predicted from B1 (702).

In the FIG. 7 example, an access unit does not necessarily include coded pictures of all enhancement layers. For example, a second access unit AU1 includes the base layer picture B1 (702), and the SNR enhancement layer picture S1 (707), but no corresponding spatial enhancement layer picture; a third access unit AU2 includes the base layer picture B2 (703); a fourth access unit AU3 includes the base layer picture B3 (704), the SNR enhancement layer picture S2 (708) and the spatial enhancement layer picture E1 (710); and a fifth access unit AU4 includes the base layer picture B4 (705).

In the FIG. 7 example, a combination of temporal, SNR and spatial scalability according to some video coding standards or technologies is shown. In those standards, spatial enhancement layer pictures (e.g., having the same spatial sizes of the E0 and E1) corresponding to the presentation time of access units AU1, AU2 and AU4 can still be reconstructed. In an example, pictures of the spatial enhancement layer that correspond to the presentation time of the access units AU1 and AU2 can be updated relative to E0 (709) with information derived from the reconstruction of B1 (702), S1 (707) and B2 (703).

It is also noted that in some video coding standards and technologies, inter-layer prediction can be temporal and can bypass layers. For example, some video coding standards and technologies can reconstruct picture E1 (710) from information derived from the reconstructed base layer B2 (703) with the SNR enhancement layer bypassed.

Further, some video coding standards and technologies can use bi-prediction. While many still associate bi-prediction with temporal layering techniques only—where one prediction source may be a past and another may be a future decoded picture in the presentation order (e.g., display order) — the concept of bi-prediction can be widely understood to encompass also inter-layer prediction. Some video coding standards and technologies include bi-prediction, which, in its generalized form as available in H.264 and later, allows, for a reconstructed sample, to refer to sample and metadata related to zero, one, or two reference blocks. In some video coding standards and technologies, such, for example, two reference blocks can be freely chosen among any previously reconstructed pictures still present in the reference picture buffer, regardless to which layer the reference blocks may belong to.

In some video coding standards or technologies, the coded picture or parts thereof, for example slices or NAL units, may include headers that allow a decoder or middlebox (e.g., a network device between a video sender and a video receiver) to identify to which layer a certain picture or its part, belongs. That information can be present in header structures, such as slice header, NAL unit header, picture header, and similar. Using such information, a decoder or a middlebox can remove pictures or parts thereof from a bitstream, or omit their decoding, when the information available in that layer is not required, or when the decoder or network has insufficient capacity to decode or convey such a layer. In an aspect, the base layer may be required in full and may form the lowest fidelity of reconstructed video. Enhancement layers, when available for decoding and after decoding, may increase fidelity in terms of time resolution/frame rate, sample fidelity, or spatial resolution.

In some video coding technologies or standards, or in their supporting infrastructure of standards documents, such as RTP payload formats, included in the bitstream or associated metadata may be a directory or table of content that describes the scalable bitstream, its layers, their inter-layer prediction dependencies and so forth. Examples for such tables include those included in the video parameter set of SHVC and VVC, or the PACSI NAL unit of RFC 6190.

According to some aspects of the present disclosure, a complexity scalability modality can be introduced as an additional scalability modality beyond temporal, SNR, and spatial scalability. In the complexity scalability modality, the base layer can have the lowest complexity and the enhancement layer(s) can have increasingly higher complexity. To simplify the description, none of the other scalability layer types are included when describing complexity scalable layers, though all other scalability layers (e.g., temporal scalability, SNR scalability, spatial scalability, and the like) can potentially co-exist with complexity scalable layers in the same scalable bitstream.

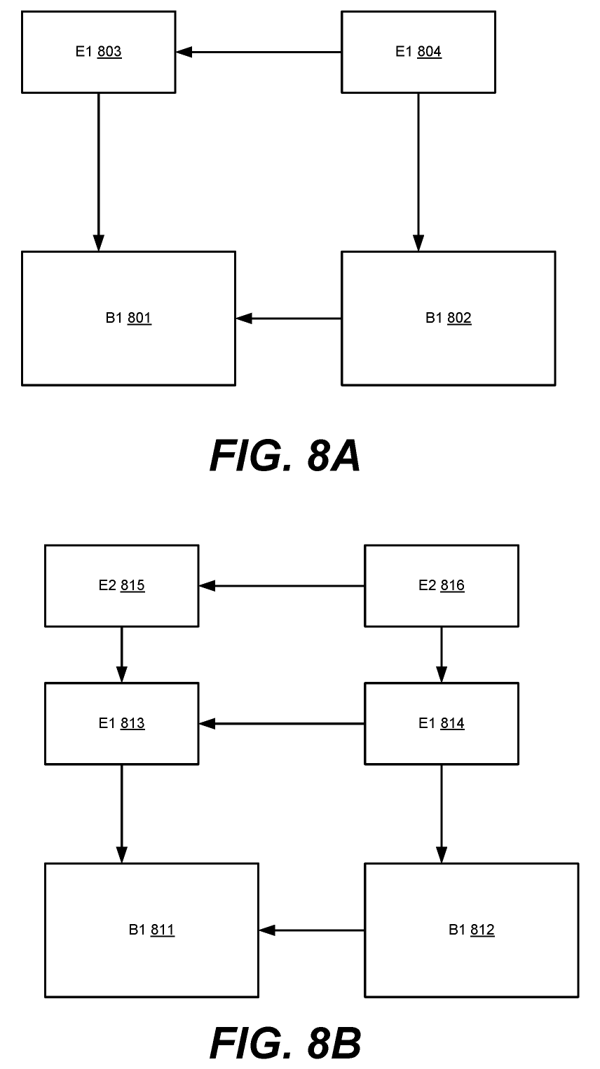

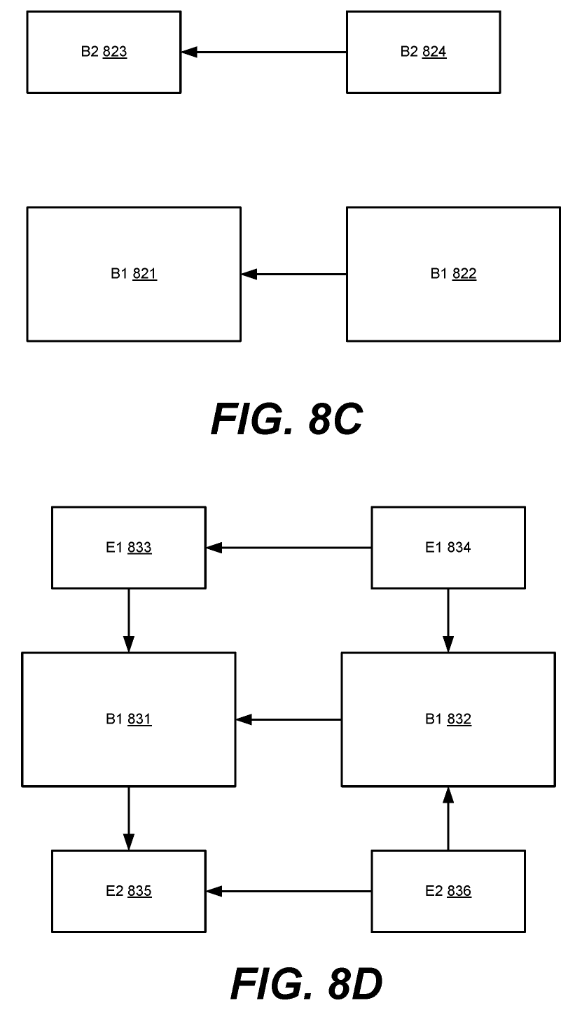

FIGS. 8A-8D show examples of coded video sequences according to some aspects of the disclosure.

FIG. 8A shows a coded video sequence including a base layer (denoted by B1) and a complexity enhancement layer (denoted by E1). The base layer includes a plurality of pictures, such as pictures (801) and (802), and the complexity enhancement layer includes a plurality of pictures, such as pictures (803) and (804).

FIG. 8B shows a coded video sequence including a base layer (denoted by B1), a first complexity enhancement layer (denoted by E1) and a second complexity enhancement layer (denoted by E2). The base layer includes a plurality of pictures, such as pictures (811) and (812); the first complexity enhancement layer includes a plurality of pictures, such as pictures (813) and (814), that refer to the base layer (only); and the second complexity enhancement includes a plurality of pictures, such as pictures (815) and (816) that can refer to both the base layer and the first complexity enhancement layer, thereby forming a hierarchical layering structure.

FIG. 8C shows a coded video sequence including a first base layer (denoted by B1) and a second base layer (denoted by B2). The first base layer includes a plurality of pictures, such as pictures (821) and (822); and the second base layer includes a plurality of pictures, such as pictures (823) and (824). In the FIG. 8C example, the first base layer and the second base layer are respectively coded with the same content without inter-layer relationship. Further, in some aspects, the first base layer and the second base layer can be respectively coded with different complexity constraints.

FIG. 8D shows a coded video sequence including a base layer (denoted by B1), a first complexity enhancement layer (denoted by E1), and a second complexity enhancement layer (denoted by E2). The base layer includes a plurality of pictures, such as pictures (831) and (832); the first complexity enhancement layer includes a plurality of pictures, such as pictures (833) and (834); and the second complexity enhancement layer includes a plurality of pictures, such as pictures (835) and (836). In the FIG. 8D, the first complexity enhancement layer and the second complexity enhancement layer both refer to the base layer only without any prediction relationship to each other.

In FIGS. 8A-8D, the size of each picture shown does not signify its sample count, but rather relates to the computational complexity for encoding and/or decoding that picture. For example, a bigger depicted picture relates to less complex coding (encoding and/or decoding), a smaller depicted picture relates to more complex coding. In some examples, the size of a depicted picture in FIGS. 8A-8D can have a reverse relationship to coded picture size. In an example, even without syntax changes (as contemplated herein), when an encoder can spend more cycles (e.g., more computations) to encode a given picture, better coding efficiency (e.g., smaller number of bits of coded picture data) may result, and hence smaller depicted picture may result.

For example, in FIG. 8A, the base layer pictures (801) and (802) are shown with larger size and are coded with less complex coding, and the enhancement layer pictures (803) and (804) are shown with smaller size and coded with more complex coding. In some examples, one or more first coding tools are used to code the base layer pictures (801) and (802), and one or more second coding tools are used to code the enhancement layer pictures (803) and (804). The one or more second coding tools have more computational complexity than the one or more first coding tools. In some examples, the enhancement layer pictures are coded with better coding efficiency (e.g., smaller number of bits per pixel) than the base layer pictures.

For example, in FIG. 8C, the first base layer pictures (821) and (822) are shown with larger size and are coded with less complex coding, and the second base layer pictures (823) and (824) are shown with smaller size and coded with more complex coding. In some examples, one or more first coding tools are used to code the first base layer pictures (821) and (822), and one or more second coding tools are used to the second base layer pictures (823) and (824). The first base layer pictures (821) and (822) have the same content as the second base layer pictures (823) and (824). The one or more second coding tools have more computational complexity than the one or more first coding tools. In some examples, a first device is configured to be able to use only the one or more first coding tools, and a second device is configured to be able to use the one or more second coding tools. The second device can operate (encode and/or decode) on the second base layer pictures (823) and (824) with higher coding efficiency (e.g., smaller number of coded bits per pixel) than the first device operating on the first base layer pictures (821) and (822).

According to another aspect, in FIGS. 8A-8D, the different depicted sizes of the coded pictures cam be indicative of their decoding complexity. Decoding complexity, here, can involve computational complexity (e.g., measured in CPU cycles per decoded sample); memory requirements, and possibly other resource driven requirements (e.g., GPU/MPU related requirements). In an example, to distinguish from spatial scalability, the pictures may be of the same spatial resolution, using the same color sampling, and so forth. As all layers are present in each AU, no temporal scalability is present in FIGS. 8A-8C. Also, the examples in FIGS. 8A-8C are different from SNR scalability in that the required coding tools for decoding can vary across layers: the base layer may be restricted in using only less complex coding tools—allowing a decoder to support only those less complex coding tools, whereas the enhancement layer may employ more complex coding tools. In some aspect of the present disclosure, the term “coding tool” is broadly constructed to include conventional coding tools; limitations on those coding tools, such as by disallowing certain mechanisms (for example disallowing very small or very large block sizes, long motion vectors, and similar); and limitations in the use of coding tools based on complexity budget considerations as described below in the context of cooperative encoding.

In some examples, quantization refinement can be used across layers for SRN scalability. In an example, the base layer is coded with a coarser quantization, and the enhancement layer can be coded with residual correction information to cause the reconstruction to be closer to the original signal. In some aspects, the complexity scalability can be applied on layers with a same quantization (e.g., fixed quantization parameter).

Referring back to FIG. 1, consider the terminal device (110) to be a sender of a video, and the terminal device (110) is a laptop with computational resources (such as a powerful CPU, accelerator circuitry, sufficient memory) to encode a complex bitstream. The receiver population of the video, such as the terminal devices (120), (130), and (140), however, may have different capabilities from each other. For example, all of the terminal devices (120), (130), and (140) can meaningfully display a certain given resolution like 1080p. The terminal device (120) also has computational resources to decode a complex bitstream (e.g., a most complex bitstream at the current time). The terminal device (130), however, may not be able to decode the most complex bitstream. The terminal device (140) may be a device several years old that has no hardware support for a modern video codec, and as a result, the terminal device (140) relies on its CPU for decoding and may be able to decode only the most basic and least complex bitstream.

In an example, referring to FIG. 8B and FIG. 1, the (sender) terminal device (110) encodes all of the base layer (B1), the first complexity enhancement layer (E1) and the second complexity enhancement layer (E2) in the FIG. 8B. The MANE (160) forwards all of the base layer (B1), the first complexity enhancement layer (E1) and the second complexity enhancement layer (E2) to the terminal device (120); the MANE (160) forwards only the base layer (B1) and the first complexity enhancement layer (E1) to the terminal device (130), and forwards only the base layer (B1) in FIG. 8B to terminal device (140). Accordingly, after receiving and decoding, the terminal device (120) can offer the best quality of reconstructed picture quality to the user, the terminal device (140) offers the worst quality, and the terminal device (130) offers quality somewhere between the best quality and the worst quality. All terminal devices, however, can reproduce the best quality allowed by their resources.

In some aspects, some codecs conforming to existing video coding standards may be able to form scalable bitstreams of pictures with the same resolution, for example 1080p using SNR scalability. By decoding of none, one, or two SNR enhancement layers, complexity scaling can be achieved. However, the complexity increase, in this case, would scale approximately linearly with the number of layers, and hence the dynamics of complexity scalability is very limited. With today’s increasingly complex coding tools, complexity scalability spanning orders of magnitudes in CPU cycles would be desirable, and even a single order of magnitude in complexity scalability would require on the order of ten SNR layers, which may be not practical or supported by today’s video coding standards.

In some aspects, to achieve better complexity scalability, at least the following issues may need to be resolved. (1). In an aspect, there exists no mechanism that can be used to specify conformance of larger or smaller decoding complexity within a given profile. Each decoder is supposed to be able to decode bitstreams of any complexity within that profile, including “evil” bitstreams. (2). In another aspect, the profile/level system as existing in current video coding standards or technologies may not be suitable to express complexity in case of grossly asymmetric encoder/decoder complexity behavior. (3). In another aspect, within the profile/level system, there are no indications per layer that allow to disable individual tools in the encoder and inform the decoder within the bitstream of such disabled tools. For example, indications in some video coding standards (e.g., H.263+), are not expressible per layer, hence it was not possible to indicate the disabling of individual tools on a per layer basis. (4). In another aspect, existing video coding standards and technologies also do not include information on how complex a certain tool is. (5). In another aspect, beyond the traditional tool domain, mechanisms indicative of decoding complexity may be useful. For example, a limitation of the vertical distance of motion vectors may allow a decoder to use fewer line buffers, which can reduce memory demands but also memory bandwidth demands—one indicator of complexity. (6). In another aspect, decoding complexity can be associated with applications of coding tools, and the decoding complexity may be configuration choices within a coding tool. For example, some modern video codecs allow partitioning and transform of variable block sizes, potentially down to small blocks such as 4x4 sample blocks or even 2x2 sample blocks. Such small block sizes are not a “tool” in the traditional sense. Not using very small block sizes can have significant coding complexity impact. Similarly, very large blocks can also pose coding complexity challenges.

When referring to coding tools hereafter, the term includes all previously mentioned tool-like mechanisms.

According to some aspects, while the selection of appropriate coding tools may be primarily a concern to manage bitstream and decoder complexity, i.e., not to overload decoders with layers they cannot decode for complexity reasons, managing encoder complexity is an even more complex subject. Historically, video coding standards specify the bitstream syntax and the decoder’s behavior upon receiving a compliant bitstream. To some extent, this logic drives the design of session announcement and call control protocols. In a one-to-many (e.g., one sender to many receivers) scenario, such as broadcast, sessions are announced, and a receiver can decide, based on received profile/level information, whether the receiver can receive and decode a given bitstream. In streaming cases, a receiver may be offered multiple different representations and can choose the one that provides the best anticipated reconstructed video quality based on its capabilities and observed network conditions. In conversational use cases, such as video conference, a sender and a receiver can perform multi-stage capability exchanges, where each side of the sender and the receiver may offer interoperability points of bitstreams they can produce, and a suitable format can be chosen based on the data exchanged using an algorithm defined in the call control protocol.

In an aspect, an encoder may be bound (e.g., constrained) by the agreed (through capability exchange) or announced (through session announcement) capabilities of connected decoder(s). Within these bounds (e.g., limits), an encoder can select any coding tool with associated complexity it wishes, implements, and/or deems advantageous for the content or other factors. Other factors may include, for example, available computational cycles at the encoder (that may be bound by hardware constraints, statistical load in a multitasking environment, or similar considerations), memory constraints, and related factors.

In some aspects, encoders can also scale complexity not only in the tool dimension (by selecting different tools), but also within each tool (e.g. by tuning how each tool is used). For instance, motion-compensated prediction can be based on motion vector search. The search range of the motion vector search can have an impact on the computational complexity, and the motion vector search range can be restricted by encoders. Similar trade-offs arise across many prediction tools. In another example, some video codecs support the coding of different block sizes using different transforms. The choice of the optimal block sizes to represent the content after transform—a process known as partitioning schemes—can be computational intensive, and encoders can limit the partitioning schemes based on complexity considerations. All these restrictions on tool flexibility can affect the decoders as well. For example, a restriction in the motion vector search range can cause changes to memory bandwidth requirements on the decoder side.

In some aspects, an encoder configured with decoder complexity in mind can allocate a complexity budge, for example expressed in cycles, memory, or comparable metrics, at the level of for each block, picture, GOP, or other relevant unit. As the encoder encodes a block or CTU, the encoder may deduct from the complexity budget, an appropriate amount based on the mechanism chosen for coding the block or CTU (e.g., selection of tools or configuration of the selected tool). When the encoder remains within the complexity budget, a decoder conforming to the complexity budget (complexity constraints) is able to decode the bitstream, even if the bitstream occasionally uses very complex tools, so long as less complex tools are used sufficiently frequent to avoid exceeding the complexity budget.

In order to be useful, the use of foregoing mechanisms may need to be signaled to the decoder, during capability exchange and/or within the bitstream. Existing video coding standards or technologies lack syntax to convey such encoder decisions, leaving decoders to infer encoder behavior through observation and guesswork. Even if a decoder observes consistent encoder behavior over a period of time, the decoder cannot rely on that the behavior continues, as the encoder may switch to more complex bitstream structures. Consequently, under current video coding standards, decoders may need to be prepared to handle the most complex bitstream—sometimes known as “evil bitstream” that exercises the most challenging code points allowed by the video coding standards, despite such complexity being rarely encountered in practice. Signaling of complexity can mitigate this issue and enable decoders to process bitstreams that, under “evil bitstream” assumption, are considered as incapable of decoding by the decoders.

According to some aspects of the present disclosure, another strategy to manage complexity is cooperative encoding. Cooperative encoding can be defined as the encoder intentionally making choices suboptimal to coding efficiency, but advantageous to the computational and/or memory complexity of both the encoder and the decoder. For example, an encoder can limit the motion vector search range, so that, the number of line buffers and the maximum memory bandwidth required on both the encoder side and the decoder side are reduced. In another example, the encoder can intentionally avoid large values in certain variables—even when the coding technology or standard allows the large values and using the large values would improve coding performance— to ensure downstream calculations remain within a maximum numeric range aligned with, for instance, a hardware word length. In another example, when the coding process according to a standard requires adding two values a and b, and each value spanning a numbering range of +/- 2^15, the sum result may exceed 16 bits for some combinations; bounding the operands can avoid such overflow.

Cooperative encoding can deliver significant benefits for software-based encoder and decoder implementations. However, in a decoder system that is designed to approach the hardware computational limits, cooperative encoding may be beneficial only when the encoder consistent use of cooperative encoding is adequately (clearly and reliably) announced to the decoder.

In some aspects, to manage decoding complexity, one or more of the following mechanisms may be applied in a bitstream and encoded in a manner that the decoder can rely on:

1. A mechanism based on per layer profile information, to codify, for each complexity scalable layer, the maximum complexity as specified by a profile definition. The per layer profile information is differ from “scalable baseline” or “scalable main” and may be vary across layers. This mechanism may be the coarsest, simplest, and least difficult mechanism for enabling complexity scalability that can be implemented in a video compression technology or standard. Similarly, per-layer level information and per-layer tier information can be included. In an example, the per-layer profile information, the per-layer level information and per-layer level information can be combined in a syntax structure profile_tier_level() that can be referred to.

2. A mechanism based on per-layer mode information expressed in one or more suitable sub-profiles. A possibly suitable signaling mechanism for sub-profiles can be used as defined in H.266/VVC, to restrict a bitstream or a layer, beyond the restriction of the profile information in use. A suitable set of sub-profiles for complexity scalability can, for example, be defined within a normative annex of a video coding technology or standard, or provided informatively. In some examples, only normative definitions may establish conformance points a decoder can rely on for complexity management purposes.

3. A mechanism based on per layer mode information, not expressed in a profile (e.g., a fixed, pre-defined combination of allowable tools), but, for example, in the form of a per-tool usage indicator. For example, such a usage indicator can be expressed in a bitmask with each bit corresponding to a given tool.

4. A mechanism based on per layer complexity information that is expressed, for example in one or more numbers indicative of complexity factors, such as CPU/GPU/NPU cycle requirements, memory bandwidth requirements, memory requirements, and so forth.

5. A mechanism based on per layer indications of cooperative encoder behavior that is expressed, for example, by bits or a bitmask indicative of certain named variables or numerically expressible codec features constrained not to exceed certain thresholds. For example, a per layer indication is used to indicate that no more than n line buffers are required for motion compensated prediction.

6. A mechanism based on decoder complexity budget information that is expressed, for example, by an abstract per-sample metric, such as cycles, memory usage, or other constraining values that the encoder commits not to exceed.

In some aspects, suitable locations for conveying one or more of the foregoing information and indications include: (1) a parameter set pertaining a given layer; (2) sequence parameter set (which pertains to a CLVS in some video coding standards); (3) a video parameter set, a scalable information SEI message, or similar high level syntax structure that includes information pertaining to individual layers or layer sets; (4) GOP-level, sequence-level, or similar level headers; (5) one or more SEI messages or equivalent that may be included in the bitstream, preferable associated with the first, or one of the first, coded pictures representing the scalable layer, and having a persistence scope that pertains to, for example, all pictures of the layer. The SEI message approach offers the advantage of integration with existing video coding standards and technologies without changing the normative syntax, but the SEI message approach has the drawback that that, in some communication scenarios, the SEI messages can be removed from the scalable bitstream as they are not required for the decoding process.

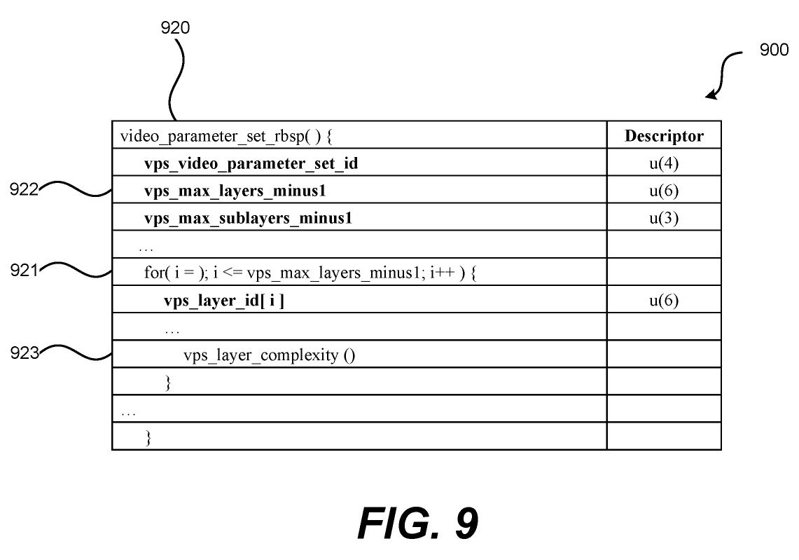

FIG. 9 shows a syntax structure (900) according to some aspects of the disclosure. The syntax structure (900) includes a video parameter set (VPS) (920) that is similar to the video parameter set in H.265 and H.266. The inter-layer relationship may be known to encoder and decoder using mechanisms specified in H.265 and H.266. One difference between the video parameter set (920) and the video parameter set specified in H.265 and H.266 is that the video parameter set (920) includes mechanisms to signal the complexity of a layer beyond the profile_tier_level () structure.

In some examples, the video parameter set (920) can be referenced using mechanisms from H.265/H.266. For example, a slice header includes a reference to a referenced picture parameter set, the referenced picture parameter set includes a reference to a sequence parameter set, and the referenced sequence parameter set includes a reference to the video parameter set (920).

The video parameter set (920) can include information pertaining to one or more layers. Various techniques can be used to codify such information. In the FIG. 9 example, the video parameter set (920) can include a loop (921) that loops over the number of layers. The number of layers can be determined, for example, according to a syntax element vps_max_layer_minus1 (922). Within the loop, the video parameter set (920) can include one or more of the syntax elements of functions, such as a function vps_layer_complexity() (923) that will be described.

In some examples, complexity related information can be signaled in other high level syntax structures, such as the SPS, or SEI messages. The SPS has a scope the coded layered video sequence (CLVS) in H.265 and H.266. It is noted that because SPSs may be included in the bitstream more frequently than VPSs, using SPSs can result unnecessarily redundant transmission of the vps_layer_complexity() syntax elements. In some examples, SEI messages are by definition not required for the decoding process, signaling complexity information in an SEI message disallows taking advantage, with respect to normative syntax, of not allowing certain tools for complexity reasons.

In the present disclosure, while signaling in the VPS is further descripted, with the understanding that the disclosed techniques can also be applied using other high level syntax structures when the associated shortcomings are either acceptable or adequately addressed.

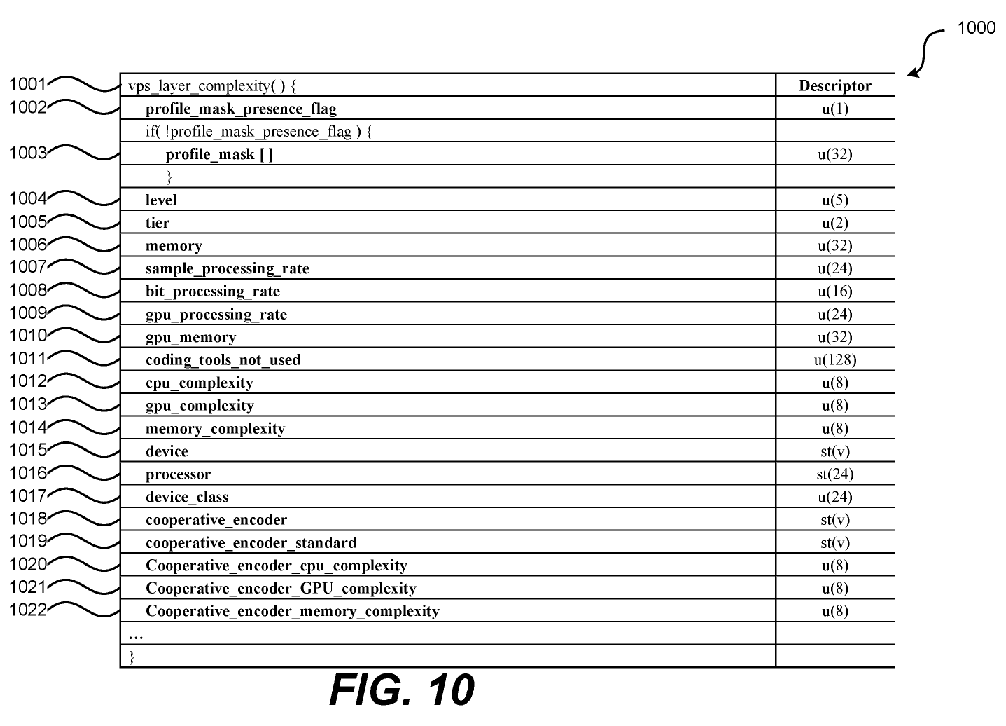

FIG. 10 shows a syntax structure (1000) according to some aspects of the disclosure. The syntax structure (1000) includes a function denoted by vps_layer_complexity() (1001). It is noted that not all syntax elements in the syntax structure (1000) need be present in every bitstream, and additional syntax elements may be defined and included within the syntax structure (1000). The syntax elements shown in the syntax structure (1000) can correspond to the six mechanisms discussed above.

It is noted that a syntax structure may involve one or more of the following syntax elements. The following syntax elements may address various mechanisms to express the decoding complexity of the layer to which the vps_layer_complexity() syntax structure applies. The syntax structure (1000) includes lines (1002) to (1022).

Line (1002) includes a presence flag profile_mask_presence_flag that can be used to gate presence of one or more syntax elements.

According to the presence flag profile_mask_presence_flag, a syntax element profile_mask[] is parsed from the bitstream, such as shown by line (1003). The syntax element profile_mask[] can be coded, for example, as a bitmask of a pre-determined number of bits. In FIG. 10 example, 32 bits are coded in the syntax element profile_mask[]. Each bit may correspond to a respective profile defined in the video coding specification. When the profile mask profile_mask[] is used, the profile mask can be indicative of the layer observing the restrictions of the intersection of restrictions of profiles whose corresponding bits are set to 1.

Line (1004) includes level (syntax element), and line (1005) includes tier (syntax element). The syntax element level can be an expression of decoding complexity measured in sample processing requirements over time. While not coded in format of resolution-frame rate, levels are commonly described as the ability to decode a given resolution, such as 1080p, at a given frame rate, such as 60 fps. A level can restrict sample processing requirements and also memory requirements. A tier can be restriction of bitrate processing requirements for a given level, and hence relates to entropy decoding performance. A vps_layer_complexity() syntax structure may impose level limits lower than imposed on the coded video sequence (CVS) in a way that the memory requirements may be determined by the level of the CVS as signaled in the referenced SPS, while the sample processing rate may be additionally restricted by the level signaled in the vps_layer_complexity() structure. A similar interpretation applies to tiers as signaled in the vps_layer_complexity() structure and the SPS.

Line (1006) includes memory (syntax element), line (1007) includes sample processing rate (syntax element), and line (1008) includes bit processing rate (syntax element) that are outside of the level/tier level system. In some examples, more restrictive constraints on memory, sample processing rate, and/or bit processing rate beyond the SPS-signaled level and tier can be included in the vps_layer_complexity() structure, in the form of quantitative restrictions (limits) that do not involve the level and tier tables. For example, the vps_layer_complexity() structure may include restrictions for sample rate processing as shown by line (1007), in the form of an integer that indicates the number of samples per second that a decoder has prepared to handle in the worst case. In an example, to avoid unnecessary precision and to save bits, such an integer can be coded in a unit indicating, for example, thousands or millions of samples per second. In an example, the sample processing rate may be measured in 1024 samples per second. A numbering range of 2^24 would accommodate resolutions exceeding 8k at 240 frames per second. Similarly coded restrictions can be included to reflect restriction on memory in the line (1006) or bit processing rate in the line (1008).

The vps_layer_complexity() structure also includes GPU-related complexity indications. In one example, decoding complexity can be differentiated between first tools that are well suited for implementation on general purpose CPUs, and second tools that may benefit from acceleration beyond general purpose CPUs, when such acceleration is widely expected to be implementable or implemented in target hardware. One example is complexity arising from the use of neural networks in the decoder. Neural networks can be efficiently implemented in massively parallel hardware architectures, such as graphics processing units (GPUs) or neural network processing units (NPUs). Levels of decoding complexity that would make real-time decoding impractical or impossible on a general purpose CPU can be readily handled by such circuitry. Recently, many hardware devices, from mobile phones up to laptops and dedicated video decoding devices can incorporate GPUs or NPUs that can be utilized for this purpose. Having a single measure to express, negotiate, or limit decoding complexity across combined GPU or CPU resources would lead to scenarios where the capabilities offered GPU-enabled devices could be severely underused, and/or where CPU-only (legacy) devices would be unable to decode a bitstream. Accordingly, one or more numerical values representing GPU processing capability, such as in the line (1009) and/or GPU memory, such as in the line (1010) may be utilized. GPU processing rate (1009) may be expressed, for example, in units of teraflops.

While expressing complexity using aforementioned, increasingly flexible and detailed, mechanisms may lead to a very good approximation of required decoder complexity, the use of the mechanisms may lead to the need to solve a multi-dimensional problem when deciding whether a certain bitstream described by such mechanisms is decodable by a given decoder. In some scenarios, simpler mechanisms may be required that, however, offer still more flexibility than the existing profile/tier/level system.

In some aspects, complexity measures can be defined that abstract from aforementioned codec specific parameters and still reflect closely on decoder complexity but are more aligned with software implementations of modern video codecs.

In some examples, the vps_layer_complexity() structure includes tool-based complexity indications.

Profiles are created in the standards committee that sets the video coding standard as a collections of coding tools to be supported by compliant decoders. Specifically, as a creator of a coding tool included in a popular profile may gain certain commercial advantages such as patent royalties associated with the inclusion of the tool, and hence the potential practicing of a patent claim, and since most organizations participating in standards setting create or contribute to at least one tool, there is a tendency that a profile may include tools that certain applications do not require, but their decoders nevertheless implement for the (perhaps sole) purpose of standards compliance.

In some examples, a coding tool introduces a degree of implementation complexity. Under the worst-case assumptions implied by profiles, provisioning in a decoder for processing using a given tool can also incur the need to set aside a certain amount of resources, for example memory or computing cycles. When a decoder knows in advance that a certain tool may not be used in a bitstream, the decoder can allocate the resources that would be necessary to support that tool for other purposes. For example, when a tool requires a very large amount of memory that would not be necessary absent the use of the tool, the decoder may support larger picture sizes or return some of the memory allocation it has asked for from the operating system for the use by other processes on the decoding machine.

In some aspects, signaling of the use of tools within a profile can be achieved, for example, by a bit mask indicative of coding tools not in use. The line (1011) includes appropriate size—such as 128 bits to signal coding tools not in use. Some or all of the included bits, may be mapped to a tool; others may initially be left undefined and assigned a semantic only in later versions of a standard. Such a bitmask can follow the example of the list of tool-related flags from the general constraints information (GCI) syntax of H.266, with the understanding that certain flags may be added or omitted relative to GCI. The technical reason for the existence of the GCI field is primarily not complexity management of the decoder but indication of IP complexity related to the bitstream. There are examples of bits that trigger the option of allowing certain highly complex mechanisms in the bitstream from an IP enforcement viewpoint, that have virtually no impact on decoding complexity. For example, the value of the gci flag related to dirty random access (e.g., gci_no_rasl_contraint_flag) is orthogonal to decoding complexity. Some fields in the GCI structure of H.266 are indicative of the potential use of highly complex coding tools and would advantageously be present also in the complexity indication as described here. The gci_no_alf_constraint, that can be used to indicate that the adaptive loop filter may not be in use, is one of such examples. An example of a bit, or a field of bits that is not present in the GCI structure that could be used to indicate complex tools would be the maximum size of the vertical motion vector component. Large vertical motion vectors can have a direct impact on the memory bandwidth that’s needed to reconstruct a given picture.

It is noted that some flags can be indicative of the non-use of coding tools allowed in a given profile that reduce decoding complexity.

The techniques described above have in an ever-increasing granularity described decoder complexity constraints on a per layer basis. When fully utilized, signaling all these options can consume a significant amount of bits in the VPS or any other syntax structure that carries the signaling. In certain use cases, especially those where repetitive inclusion of VPSs in the bitstream is necessary to allow tune-in (for example, so-called random access bitstreams), loading up the VPS with so much information can be counter-productive to bitstream/compression performance. In such cases, different mechanisms may be employed.

In some examples, the vps_layer_complexity() structure includes abstract decoding complexity/memory indications.

In an aspect, for certain coding tools, the increases in the decoding complexity and/or the memory demand can be quantified. As an extreme example, neural-network based decoding tools, running on a general purpose CPU, can increase the decoding complexity by a factor of, for example 50. In another example, the use of an adaptive loop filter may increase the decoding complexity by 5%. For every major tool, an experts’ group, such as a standardization committee, may agree on a number indicative of a numerical CPU complexity increase number over a baseline bitstream complexity that may include only the most basic tools. Such number may be accumulated or otherwise set into a relation so to create a, for example, single complexity number for a given layer bitstream that is based on the coding tools potentially used in that bitstream. The line (1012) includes a first number that can be incorporated into a complexity indication; the line (1013) includes a second number that can be incorporated into a complexity indication using GPUs; and line (1014) includes a third number that can be incorporated into complexity indication for memory requirements. Other such numbers can be aggregated to signal other accumulative complexity measures.

In some examples, the vps_layer_complexity() structure includes devices and device classes for complexity indications.

In an aspect, a pragmatic mechanism that may be particularly useful outside of standardization work can be that the complexity of a bitstream be signaled by identifying an example device or devices on which, the bitstream is expected to be decodable assuming an appropriate player software. For example, a bitstream may indicate that the bitstream can be decoded on an iPhone16, but (implicatively or expressively indicate) not on earlier iPhone devices. The line (1015) includes a string for this mechanism. The string could, for example, be formed as a comma-separated list of device names, such as “iPhone16, google Pixel Pro 9, Huawei P60”. A similar indication may reference the CPU or SOC on which decoding may be possible. The line (1016) includes a string for such indication, such as “Apple A18, tensor G4, QC Snapdragon SM8475”. A decoder operating on a listed device can, with reasonable certainty, decode the bitstream. Decoders running on unlisted devices can decide whether to attempt to decode or reject a bitstream based on application logic that includes information about commonly deployed devices from other vendors.

In some examples, devices can be grouped in device classes, and the class identifier is used to indicate the device class. For example, the line (1017) includes an integer or a variable length integer with semantics defined to indicate the device class. For example, high-end smartphones of a given release year can be grouped together in a class that is assigned a certain integer value. For example, high-end smartphones of release year 2022 could be labelled as 20220, high-end smartphones of release year 2023 can be labelled as 20230, and so forth. The numbering scheme can be extended to include “mainstream” and “budget” phones for a given year, as well as other devices. For example, for the release year 2022, a high-end smartphone may be labelled as 20220, a mainstream smartphone 20221, a budget smartphone 20222, a tablet 20223, and so forth.

It is noted that, while a bitstream creator cannot test every bitstream across all potential devices, the use of a device class may at least provide a high likelihood that a device in a given class (for example, 2024-generation high end smartphones) can decode the bitstream or layer. Bitstream creators can adopt a conservative labeling strategy, targeting a spectrum between the highest number of devices that should have a high chance of decoding a so labelled bitstream versus a likely much smaller number that are virtually guaranteed to be able to decode the bitstream or layer.

In some examples, the vps_layer_complexity() structure includes complexity indications for cooperative encoding.

In an aspect, except for devices and device class indications, the mechanisms describe above assume worst-case bitstream complexity within the indicated constraints. For example, when a particularly complex tool can be decided at coding tree unit (CTU) level (rather than picture, layer, or bitstream level), the indicated complexity is based on that the particularly complex tool is employed in every CTU when the complex tool is allowed in the combination of profile/tier/level and one or more of the other complexity indications described above. For hardware implementations which do not have the benefit of joint resource allocation among tasks/processes, that may be an appropriate choice. However, for software implementation, an approach that takes advantage from the typical, rather than worst-case, bitstream complexity as found in the field can be more suitable.

Cooperative encoding refers to techniques in which the encoder intentionally deviates from the strictly optimal choice of coding mode or modes for a given unit, such as a block, CTU, picture, or group of pictures, accepting some loss in coding efficiency, such that a decoder that operates under complexity-constraint decoder can still decode the bitstream or layer. For example, CTUs that are encoded using extreme transform sizes, such as very small (e.g., 2x2 or 4x4 transform sizes) or very large transform size (e.g., 256x256 transform size), may be particularly complex to decode. For a given picture size, a decoder running on a certain device may be able to decode a small percentage (for example, 2% to 5%) of such highly complex CTUs, but no more. In a purely tool/profile based system, that decoder can in many cases reject a bitstream of the given picture size, because absent cooperative decoding behavior, the decoder has to be prepared to decode the worst case (“evil”) bitstream composed entirely of CTUs with the extreme transform sizes, such as 2x2, 4x4 or 256x256 transform sizes. However, when the decoder knows that the encoder cooperative constraints, and would not apply the extreme transform sizes on more than a pre-defined, small proportion (e.g., 6%) of CTUs, the decoder can attempt and often succeed in decoding the bitstream.

In some walled-garden environments, as well as in certain commercial applications that accept the risk of user dissatisfaction, cooperative encoding can be used. When bitstreams or layers are not labelled in an interoperable way, decoders that require cooperative encoding are deemed non-compliant under the logic of many video coding standards, which can have negative commercial implications.

In order to indicate cooperative encoding, on a per layer basis, the complexity indication can include one or more of the following codepoints.

In a first example, a first approach that operates in a walled garden environment, or a downstream standards environment is used. In these scenarios, the walled-garden specification or the downstream standard can impose certain restrictions for cooperative encoders and conformance to the restrictions can be indicated, on a per layer basis, in the complexity indication. The indication may be in the form of a text string, such as shown in the line (1018) in FIG. 10 example, which can, for example, provide vendor-specific information, such as a product name and a version number of an encoder, the cooperation type or level of encoder cooperation under which the bitstream was encoded, and so forth. For example, such a string can be “Tencent266, v2.1.2, 0x1234”. In a walled-garden setting, this information can be recognized and used by decoders to decide whether a bitstream or a layer in the bitstream is decodable. In a downstream standard setting, a string, such as shown in the line (1019) in FIG. 10 can be used. For example, the string in the line (1019) can be composed as “DVB H.266 codec restriction (2025), clause 3.4.5”. The technical advantages of putting such information in a normative part of the syntax rather than an SEI message or similar can include: a) parameter sets, such as the VPS, are sometimes used for capability exchange (e.g., in RTP/webrtc related standards), whereas SEI messages are not; b) parameter sets can be available prior to decoding, while SEI messages cannot appear as the first NAL units in a bitstream, and hence at least partial decoding is operated before the bitstream should be rejected.

In a second example, a second approach is suitable in an interoperability environment among vendors, even without downstream standards efforts. As described above, abstract decoding complexity numbers can be used. An encoder can decide such a complexity number as a ceiling for a given layer/bitstream not to exceed, and signal the complexity number in the complexity indication. Within a complexity budget indicated by the complexity number, the encoder can use a combination of complex and less complex coding tools at will, or can chose the combination more precisely by using the rate-distortion optimization, and use the combination of complex or less complex coding tools as necessary to represent the content, so that, in a given granularity such as a single coded picture, the complexity budget as indicated by the complexity number is not exceeded. The complexity number to which the bitstream adheres to can be coded in the complexity indication, for example, an integer in the line (1020) in FIG. 10. Similar complexity numbers can be calculated for GPU, such as an integer in the line (1021) in FIG. 10, and memory requirements, such as an integer in the line (1022) in FIG. 10 for decoding. The cooperative encoding approach can also be used in combination with device and device class indications as described above.

In an aspect, cooperative encoding, unlike certain other technologies mentioned above, can operate well in a single layer environment; that is, without the use of layers and, in some video coding standards, without the presence of a video parameter set. In such non-layered environments, codepoints that convey complexity indications can be placed in normative syntax structures pertaining to one or more pictures, such as the sequence parameter set (SPS). In some examples, however, a normative syntax structure that applies to the whole scalable or non-scalable bitstream can be used to carry complexity indications, as the complexity of a decoder used to decode a bitstream is unlikely to change across coded video sequences (CVS), and therefore complexity constraints may pertain to many or all of the CVS of a bitstream and hence the bitstream itself. Techniques to express such a situation in the syntax of an SPS can be used. For example, a condition of bitstream conformance that previously signaled complexity indication never changes within a bitstream (and hence to be the same in all SPSs of the bitstream), or may change but only in the direction of less complexity can be applied.

In some aspects, complexity management can include using complex/efficient and less-complex/less-efficient layers to represent certain content.

Another approach of complexity management can be employed in layered scenarios, and suitable in scenarios where multiple layer-like structures exist without the directed graph relationship (e.g., use, dependency, reference) to layers. The layer-like structures can correspond to views in Multiview coding: while from a syntax viewpoint, views may be coded like layers, there is not necessarily a defined use (e.g., dependency) relationship between those views except a potential reference to a single base view.

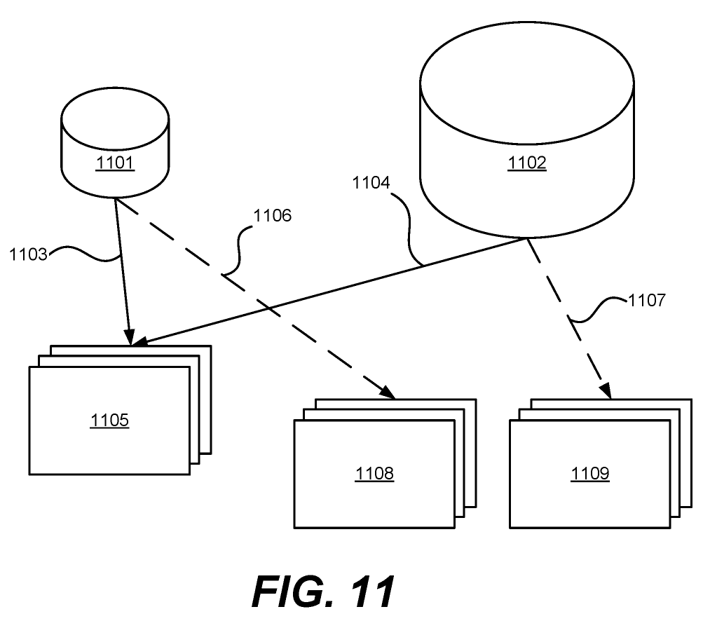

FIG. 11 shows a diagram of complex management according to some aspects of the disclosure. FIG. 11 shows a high complex representation layer (1101) and a low complex representation layer (1102). In an example, the high complex representation layer (1101) and the low complex representation layer (1102) can be decoded separately, such as indicated by solid lines (1103) and (1104). The decoding of the high complex representation layer (1101) and the decoding of the low complex representation layer (1102) respectively result the same reconstructed sample stream (1105). In an example, the high complex representation layer (1101) and the low complex representation layer (1102) can be decoded separately to generate bit-exact results. In another scenario, the high complex representation layer (1101) and the low complex representation layer (1102) are respectively (independently) decoded, such as represented by dashed lines (1106) and (1107), and two sample streams (1108) and (1109) are generated as the result of the decoding. The two sample streams (1108) and (1109) may be visually the same but may not be bit-exact, or visible different but still represent the same content and are deemed similar enough for a given application.

In the FIG. 11 example, the high complex representation layer (1101) is depicted smaller than the low complex representation layer (1102) because the high complexity layer is encoded without consideration of decoder complexity, which may result into fewer bits.

When using lossy compression, bit-exact reconstruction of a bit-exact output sample stream (1105) from two divergent sources, such as the high complex representation layer (1101) and the low complex representation layer (1102) may require encoders that incorporate closely coordinate when encoding the high complex representation layer (1101) and the low complex representation layer (1102). Application of some coding tools may inevitably lead to drift between reconstructed bitstreams, and the encoders that encode the high complex representation layer (1101) and the low complex representation layer (1102) need to coordinate in that they apply such coding tools exactly the same, or use other techniques to avoid drifting, such as those based on H.264’s S-frames. In an example, alternative tools for the purpose of bit-exact decoding and avoiding drifting can have significant complexity impact. One example of such tools can be entropy coding. For example, H.264 had two entropy coding options, known as CA-VLC with comparatively low complexity, and CABAC with comparatively high complexity. The CA-VLC and CABAC can have bit-exact symbol reconstruction. When the same symbols are fed into a CA-VLC and a CABAC engine, the reconstructed symbols are bit exact (the same). Accordingly, for example, a first encoder that creates the high complex representation layer (1101) can operate using CABAC and optimize for CABAC entropy decoding, for example the rate-distortion optimization in the encoder assuming CABAC decoding. A second encoder that creates the low complex representation layer (1102), however, may use the symbols created by the CABAC encoder (the first encoder) and encode using CA-VLC entropy coding instead. The result can be two layers (1101) and (1102) that can result bit-exact reconstruction to the same reconstructed sample stream (1105) but trade off differently with respect to compression efficiency (a CABAC bitstream based on the high complex representation layer (1101) may be more efficiency than a CA-VLS bitstream based on the low complex representation layer (1102)), and the CABAC bitstream is more complex to decode than the CA-VLC bitstream. The complex management technique is illustrated based on CABAC and CA-VLC, the complex management technique can be applied to other examples. For example, in some video codecs, the initialization of CABAC engines plays an increasing role, both in terms of gaining coding efficiency and in terms of complexity. In some examples, a first encoder can be devised to perform full CABAC initialization based on a symbol stream and create the high complex representation layer (1101), and a cooperating encoder (e.g., a second encoder) of the first encoder may take the same symbol stream but skip all complex CABAC initialization steps and perform uninitialized CABAC to generate the low complex representation layer (1102) that still ensures bit-exact reconstruction.

When bit-exact reconstruction is not required, additional mechanisms can be employed. For example, two encoders can be configured so that, for some or all pictures, a first encoder of the two encoders creates a best possible bitstream independent of complexity considerations, such as the high complex representation layer (1101), while a second encoder of the two encoders optimizes the bitstream for a certain level of decoding complexity to update the bitstream, such as the low complex representation layer (1102). Such complexity can be signaled in the bitstream using, for example, one of the mechanisms describe above. In some examples, a decoder may switch, based on such mechanism in the bitstream, from one to the other (e.g., a switch from the dashed line (1106) to the dashed line (1007)) at certain points in the bitstreams, for example at the boundaries of coded video sequences. The result can be two visually similar, but not bit exact, reconstructed picture sequences (1108) and (1009). Such an approach may be advantageous when the decoder runs on a multi-process platform where the number of cycles available for video decoding may change based on the load from other processes.

In an aspect, coded video sequences can include pictures that are not used for prediction. These pictures can be reconstructed from either a low complexity or high complexity enhancement layer depending on decoder resources. Whereas reference layers require non-complexity-scalable resources, the highest enhancement layer pictures can be reconstructed based on CPU cycle, GPU cycle, or memory cycle availability. In an example, complexity scalability can be implemented in a degenerated form that omits enhancement layer decoding altogether when running out of cycles or memory. In an aspect of the present disclosure, complexity scalability can be implemented in a form that offers additional quality points (e.g., intermediate quality points) between decoding the highest enhancement layer and not decoding the highest enhancement layer.S

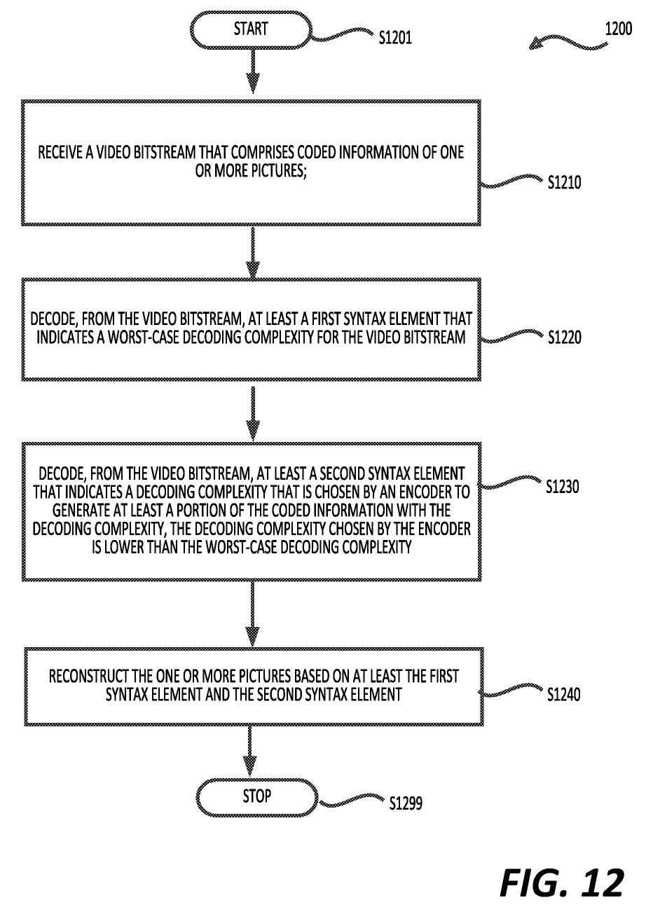

FIG. 12 shows a flow chart outlining a process (1200) according to an aspect of the disclosure. The process (1200) can be used in a video decoder. In various aspects, the process (1200) is executed by processing circuitry, such as the processing circuitry that performs functions of the video decoder (110), the processing circuitry that performs functions of the video decoder (210), and the like. In some aspects, the process (1200) is implemented in software instructions, thus when the processing circuitry executes the software instructions, the processing circuitry performs the process (1200). The process starts at (S1201) and proceeds to (S1210).

At (S1210), a video bitstream is received. The bitstream includes coded information of one or more pictures.

At (S1220), from the video bitstream, at least a first syntax element that indicates a worst-case decoding complexity for the video bitstream is decoded.

At (S1230), from the video bitstream, at least a second syntax element is decoded, at least the second syntax element indicates a decoding complexity that is chosen by an encoder to generate at least a portion of the coded information with the decoding complexity. The decoding complexity chosen by the encoder is lower than the worst-case decoding complexity.

At (S1240), the one or more pictures are reconstructed based on at least the first syntax element and at least the second syntax element.

In some examples, at least the first syntax element includes at least one of a profile indictor, a tier indictor, and a level indicator.

In some examples, the video bitstream includes one or more coded layer video sequences (also referred to as one or more layers) and at least the second syntax element is associated with a coded layer video sequence in the one or more coded layer video sequences.

In some aspects, at least the second syntax element is decoded from a parameter set. In some examples, at least the second syntax element is decoded from a video parameter set (VPS) when the video bitstream has a layered structure with one or more coded layer video sequences. In some examples, at least the second syntax element is decoded from a sequence parameter set (SPS) when the video bitstream has a non-layered structure with a single video sequence (also referred to as single layer).

In some aspects, at least the first syntax element indicates coding tools that have the worst-case decoding complexity, and at least the second syntax element indicates a subset of the coding tools that has the decoding complexity that is lower than the worst-case decoding complexity.

In some aspects, at least the first syntax element indicates configurable options within at least a coding tool that have the worst-case decoding complexity, and at least the second syntax element indicates a subset of the configurable options that has the decoding complexity lower than the worst-case decoding complexity.

In some aspects, the second syntax element is indicative of a decoding complexity budget that is chosen by the encoder to generate at least the portion of the coded information, a decoding of at least the portion of the coded information being within the decoding complexity budget.

In some aspects, the second syntax element indicates at least one of: a profile mask; a level indicator; a tier indicator; a memory restriction indicator; a sample processing rate restriction indicator; a bit processing rate restriction indicator; a GPU processing rate restriction indicator; a GPU memory restriction indicator; a coding tool mask; a CPU complexity indictor; a GPU complexity indictor; a memory complexity indicator; a device restriction indicator; a processor restriction indicator; a device class restriction indicator; a cooperative encoder indicator; a cooperative encoder standard indictor; a cooperative encoder CPU complexity budget indicator; a cooperative encoder GPU complexity budget indicator; and/or a cooperative encoder memory complexity budget indictor.

Then, the process proceeds to (S1299) and terminates.

The process (1200) can be suitably adapted. Step(s) in the process (1200) can be modified and/or omitted. Additional step(s) can be added. Any suitable order of implementation can be used.

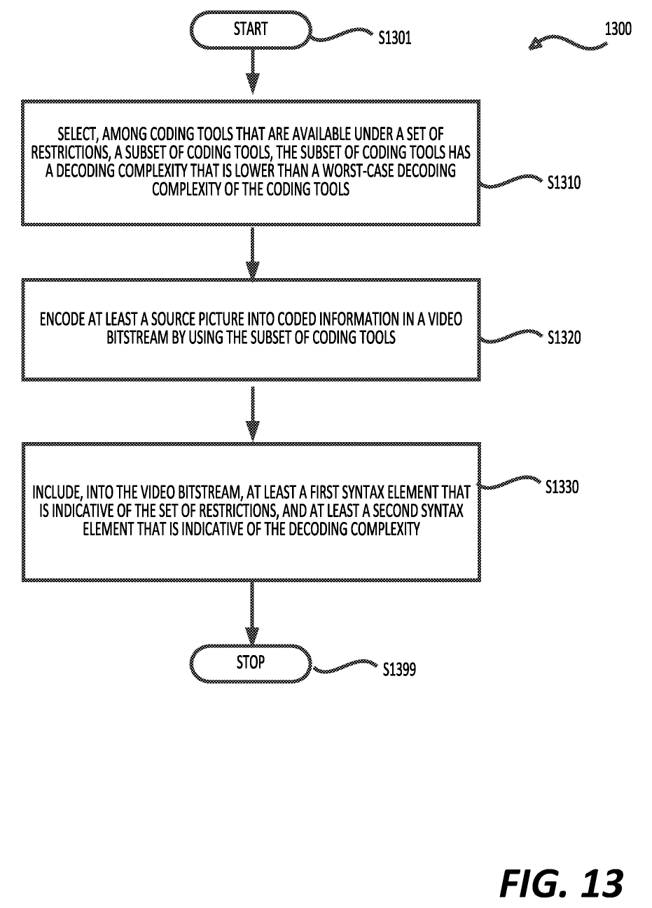

FIG. 13 shows a flow chart outlining a process (1300) according to an aspect of the disclosure. The process (1300) can be used in a video encoder. In various aspects, the process (1300) is executed by processing circuitry, such as the processing circuitry that performs functions of the video encoder (103), the processing circuitry that performs functions of the video encoder (303), and the like. In some aspects, the process (1300) is implemented in software instructions, thus when the processing circuitry executes the software instructions, the processing circuitry performs the process (1300). The process starts at (S1301) and proceeds to (S1310).

At (S1310), among coding tools that are available under a set of restrictions, a subset of coding tools is selected, the subset of coding tools has a decoding complexity that is lower than a worst-case decoding complexity of the coding tools.

At (S1320), at least a source picture is encoded into coded information in a video bitstream by using the subset of coding tools.

At (S1330), at least a first syntax element that is indicative of the set of restrictions, and at least a second syntax element that is indicative of the decoding complexity are included, into the video bitstream.

In some aspects, at least the first syntax element includes at least one of a profile indictor, a tier indictor, and a level indicator.

In some aspects, the video bitstream includes one or more coded layer video sequences and at least the second syntax element is associated with a coded layer video sequence in the one or more coded layer video sequences.

In some aspects, at least the second syntax element is in a parameter set. In some examples, at least the second syntax element is in a video parameter set (VPS) when the video bitstream has a layered structure with one or more coded layer video sequences.

In some examples, at least the second syntax element is in a sequence parameter set (SPS) when the video bitstream has a non-layered structure with a single video sequence.

In some examples, at least a coding tool of the coding tools comprises a plurality of configurable options within the coding tool, and at least the second syntax element indicates a subset of the plurality of configurable options that has the decoding complexity that is lower than the worst-case decoding complexity.

In some aspects, the second syntax element is indicative of a decoding complexity budget that is chosen to generate the coded information, a decoding of the coded information is within the decoding complexity budget.

In some aspects, the second syntax element indicates at least one of: a profile mask; a level indicator; a tier indicator; a memory restriction indicator; a sample processing rate restriction indicator; a bit processing rate restriction indicator; a GPU processing rate restriction indicator; a GPU memory restriction indicator; a coding tool mask; a CPU complexity indictor; a GPU complexity indictor; a memory complexity indicator; a device restriction indicator; a processor restriction indicator; a device class restriction indicator; a cooperative encoder indicator; a cooperative encoder standard indictor; a cooperative encoder CPU complexity budget indicator; a cooperative encoder GPU complexity budget indicator; and/or a cooperative encoder memory complexity budget indictor.

Then, the process proceeds to (S1399) and terminates.

The process (1300) can be suitably adapted. Step(s) in the process (1300) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

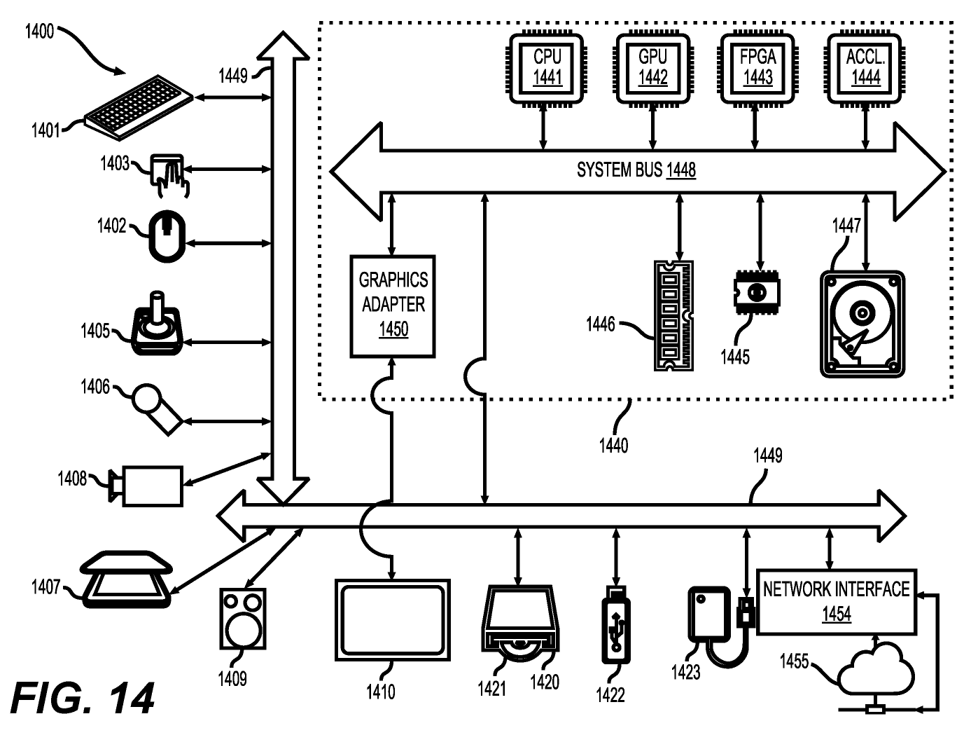

The techniques described above, can be implemented as computer software using computer-readable instructions and physically stored in one or more computer-readable media. For example, FIG. 14 shows a computer system (1400) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 14 for computer system (1400) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (1400).

Computer system (1400) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1401), mouse (1402), trackpad (1403), touch screen (1410), data-glove (not shown), joystick (1405), microphone (1406), scanner (1407), camera (1408).

Computer system (1400) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1410), data-glove (not shown), or joystick (1405), but there can also be tactile feedback devices that do not serve as input devices), audio output devices (such as: speakers (1409), headphones (not depicted)), visual output devices (such as screens (1410) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (1400) can also include human accessible storage devices and their associated media such as optical media including CD/DVD ROM/RW (1420) with CD/DVD or the like media (1421), thumb-drive (1422), removable hard drive or solid state drive (1423), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1400) can also include an interface (1454) to one or more communication networks (1455). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1449) (such as, for example USB ports of the computer system (1400)); others are commonly integrated into the core of the computer system (1400) by attachment to a system bus as described below (for example Ethernet interface into a PC computer system or cellular network interface into a smartphone computer system). Using any of these networks, computer system (1400) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1440) of the computer system (1400).

The core (1440) can include one or more Central Processing Units (CPU) (1441), Graphics Processing Units (GPU) (1442), specialized programmable processing units in the form of Field Programmable Gate Areas (FPGA) (1443), hardware accelerators for certain tasks (1444), graphics adapters (1450), and so forth. These devices, along with Read-only memory (ROM) (1445), Random-access memory (1446), internal mass storage such as internal non-user accessible hard drives, SSDs, and the like (1447), may be connected through a system bus (1448). In some computer systems, the system bus (1448) can be accessible in the form of one or more physical plugs to enable extensions by additional CPUs, GPU, and the like. The peripheral devices can be attached either directly to the core’s system bus (1448), or through a peripheral bus (1449). In an example, the screen (1410) can be connected to the graphics adapter (1450). Architectures for a peripheral bus include PCI, USB, and the like.

CPUs (1441), GPUs (1442), FPGAs (1443), and accelerators (1444) can execute certain instructions that, in combination, can make up the aforementioned computer code. That computer code can be stored in ROM (1445) or RAM (1446). Transitional data can also be stored in RAM (1446), whereas permanent data can be stored for example, in the internal mass storage (1447). Fast storage and retrieve to any of the memory devices can be enabled through the use of cache memory, that can be closely associated with one or more CPU (1441), GPU (1442), mass storage (1447), ROM (1445), RAM (1446), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1400), and specifically the core (1440) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1440) that are of non-transitory nature, such as core-internal mass storage (1447) or ROM (1445). The software implementing various aspects of the present disclosure can be stored in such devices and executed by core (1440). A computer-readable medium can include one or more memory devices or chips, according to particular needs. The software can cause the core (1440) and specifically the processors therein (including CPU, GPU, FPGA, and the like) to execute particular processes or particular parts of particular processes described herein, including defining data structures stored in RAM (1446) and modifying such data structures according to the processes defined by the software. In addition or as an alternative, the computer system can provide functionality as a result of logic hardwired or otherwise embodied in a circuit (for example: accelerator (1444)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features can be combined in various manners and are not limited to the combinations noted below.

(1). A method of video decoding, including: receiving a video bitstream that includes coded information of one or more pictures; decoding, from the video bitstream, at least a first syntax element that indicates a worst-case decoding complexity for the video bitstream; decoding, from the video bitstream, at least a second syntax element that indicates a decoding complexity that is chosen by an encoder to generate at least a portion of the coded information with the decoding complexity, the decoding complexity chosen by the encoder being lower than the worst-case decoding complexity; and reconstructing the one or more pictures based on at least the first syntax element and at least the second syntax element.

(2). The method of feature (1), in which at least the first syntax element includes at least one of a profile indictor, a tier indictor, and a level indicator.

(3). The method of any of features (1) to (2), in which the video bitstream includes one or more coded layer video sequences and at least the second syntax element is associated with a coded layer video sequence in the one or more coded layer video sequences.

(4). The method of any of features (1) to (3), in which at least the second syntax element is decoded from a parameter set.

(5). The method of any of features (1) to (4), in which at least the second syntax element is decoded from a video parameter set (VPS) when the video bitstream has a layered structure with one or more coded layer video sequences.

(6). The method of any of features (1) to (5), in which at least the second syntax element is decoded from a sequence parameter set (SPS) when the video bitstream has a non-layered structure with a single video sequence.

(7). The method of any of features (1) to (6), in which at least the first syntax element indicates coding tools that have the worst-case decoding complexity, and at least the second syntax element indicates a subset of the coding tools that has the decoding complexity that is lower than the worst-case decoding complexity.

(8). The method of any of features (1) to (7), in which at least the first syntax element indicates configurable options within at least a coding tool that have the worst-case decoding complexity, and at least the second syntax element indicates a subset of the configurable options that has the decoding complexity lower than the worst-case decoding complexity.

(9). The method of any of features (1) to (8), in which the second syntax element is indicative of a decoding complexity budget that is chosen by the encoder to generate at least the portion of the coded information, a decoding of at least the portion of the coded information being within the decoding complexity budget.

(10). The method of any of features (1) to (9), in which the second syntax element indicates at least one of: a profile mask; a level indicator; a tier indicator; a memory restriction indicator; a sample processing rate restriction indicator; a bit processing rate restriction indicator; a GPU processing rate restriction indicator; a GPU memory restriction indicator; a coding tool mask; a CPU complexity indictor; a GPU complexity indictor; a memory complexity indicator; a device restriction indicator; a processor restriction indicator; a device class restriction indicator; a cooperative encoder indicator; a cooperative encoder standard indictor; a cooperative encoder CPU complexity budget indicator; a cooperative encoder GPU complexity budget indicator; and/or a cooperative encoder memory complexity budget indictor.

(11). A method of video encoding, including: selecting, among coding tools that are available under a set of restrictions, a subset of coding tools, the subset of coding tools having a decoding complexity that is lower than a worst-case decoding complexity of the coding tools; encoding at least a source picture into coded information in a video bitstream by using the subset of coding tools; and including, into the video bitstream, at least a first syntax element that is indicative of the set of restrictions, and at least a second syntax element that is indicative of the decoding complexity.

(12). The method of feature (11), in which at least the first syntax element includes at least one of a profile indictor, a tier indictor, and a level indicator.

(13). The method of any of features (11) to (12), in which the video bitstream includes one or more coded layer video sequences and at least the second syntax element is associated with a coded layer video sequence in the one or more coded layer video sequences.

(14). The method of any of features (11) to (13), in which at least the second syntax element is in a parameter set.

(15). The method of any of features (11) to (14), in which at least the second syntax element is in a video parameter set (VPS) when the video bitstream has a layered structure with one or more coded layer video sequences.

(16). The method of any of features (11) to (15), in which at least the second syntax element is in a sequence parameter set (SPS) when the video bitstream has a non-layered structure with a single video sequence.

(17). The method of any of features (11) to (16), in which at least a coding tool of the coding tools includes a plurality of configurable options within the coding tool, and at least the second syntax element indicates a subset of the plurality of configurable options that has the decoding complexity that is lower than the worst-case decoding complexity.

(18). The method of any of features (11) to (17), in which the second syntax element is indicative of a decoding complexity budget that is chosen to generate the coded information, a decoding of the coded information being within the decoding complexity budget.

(19). The method of any of features (11) to (18), in which the second syntax element indicates at least one of: a profile mask; a level indicator; a tier indicator; a memory restriction indicator; a sample processing rate restriction indicator; a bit processing rate restriction indicator; a GPU processing rate restriction indicator; a GPU memory restriction indicator; a coding tool mask; a CPU complexity indictor; a GPU complexity indictor; a memory complexity indicator; a device restriction indicator; a processor restriction indicator; a device class restriction indicator; a cooperative encoder indicator; a cooperative encoder standard indictor; a cooperative encoder CPU complexity budget indicator; a cooperative encoder GPU complexity budget indicator; and/or a cooperative encoder memory complexity budget indictor.

(20). A non-transitory computer-readable storage medium storing instructions which when executed by a processor cause the processor to perform an encoding method, the encoding method including: selecting, among coding tools that are available under a set of restrictions, a subset of coding tools, the subset of coding tools having a decoding complexity that is lower than a worst-case decoding complexity of the coding tools; encoding at least a source picture into coded information in a video bitstream by using the subset of coding tools; including, into the video bitstream, at least a first syntax element that is indicative of the set of restrictions, and at least a second syntax element that is indicative of the decoding complexity; and transmitting the video bitstream.

(21). An apparatus for video decoding, including processing circuitry that is configured to perform the method of any of features (1) to (10).

(22). An apparatus for video encoding, including processing circuitry that is configured to perform the method of any of features (11) to (19).

(23). A non-transitory computer-readable storage medium storing instructions which when executed by at least one processor cause the at least one processor to perform the method of any of features (1) to (20).

What is claimed is:

1. A method of video decoding, comprising:
receiving a video bitstream that comprises coded information of one or more pictures;
decoding, from the video bitstream, at least a first syntax element that indicates a worst-case decoding complexity for the video bitstream;
decoding, from the video bitstream, at least a second syntax element that indicates a decoding complexity that is chosen by an encoder to generate at least a portion of the coded information with the decoding complexity, the decoding complexity chosen by the encoder being lower than the worst-case decoding complexity; and
reconstructing the one or more pictures based on at least the first syntax element and at least the second syntax element.

2. The method of claim 1, wherein at least the first syntax element comprises at least one of a profile indictor, a tier indictor, and a level indicator.

3. The method of claim 1, wherein the video bitstream comprises one or more coded layer video sequences and at least the second syntax element is associated with a coded layer video sequence in the one or more coded layer video sequences.

4. The method of claim 1, wherein at least the second syntax element is decoded from a parameter set.

5. The method of claim 4, wherein at least the second syntax element is decoded from a video parameter set (VPS) when the video bitstream has a layered structure with one or more coded layer video sequences.

6. The method of claim 4, wherein at least the second syntax element is decoded from a sequence parameter set (SPS) when the video bitstream has a non-layered structure with a single video sequence.

7. The method of claim 1, wherein at least the first syntax element indicates coding tools that have the worst-case decoding complexity, and at least the second syntax element indicates a subset of the coding tools that has the decoding complexity that is lower than the worst-case decoding complexity.

8. The method of claim 1, wherein at least the first syntax element indicates configurable options within at least a coding tool that have the worst-case decoding complexity, and at least the second syntax element indicates a subset of the configurable options that has the decoding complexity lower than the worst-case decoding complexity.

9. The method of claim 1, wherein the second syntax element is indicative of a decoding complexity budget that is chosen by the encoder to generate at least the portion of the coded information, a decoding of at least the portion of the coded information being within the decoding complexity budget.

10. The method of claim 1, wherein the second syntax element indicates at least one of:
a profile mask;
a level indicator;
a tier indicator;
a memory restriction indicator;
a sample processing rate restriction indicator;
a bit processing rate restriction indicator;
a GPU processing rate restriction indicator;
a GPU memory restriction indicator;
a coding tool mask;
a CPU complexity indictor;
a GPU complexity indictor;
a memory complexity indicator;
a device restriction indicator;
a processor restriction indicator;
a device class restriction indicator;
a cooperative encoder indicator;
a cooperative encoder standard indictor;
a cooperative encoder CPU complexity budget indicator;
a cooperative encoder GPU complexity budget indicator; and/or
a cooperative encoder memory complexity budget indictor.

11. A method of video encoding, comprising:
selecting, among coding tools that are available under a set of restrictions, a subset of coding tools, the subset of coding tools having a decoding complexity that is lower than a worst-case decoding complexity of the coding tools;
encoding at least a source picture into coded information in a video bitstream by using the subset of coding tools; and
including, into the video bitstream, at least a first syntax element that is indicative of the set of restrictions, and at least a second syntax element that is indicative of the decoding complexity.

12. The method of claim 11, wherein at least the first syntax element comprises at least one of a profile indictor, a tier indictor, and a level indicator.

13. The method of claim 11, wherein the video bitstream comprises one or more coded layer video sequences and at least the second syntax element is associated with a coded layer video sequence in the one or more coded layer video sequences.

14. The method of claim 11, wherein at least the second syntax element is in a parameter set.

15. The method of claim 14, wherein at least the second syntax element is in a video parameter set (VPS) when the video bitstream has a layered structure with one or more coded layer video sequences.

16. The method of claim 14, wherein at least the second syntax element is in a sequence parameter set (SPS) when the video bitstream has a non-layered structure with a single video sequence.

17. The method of claim 11, wherein at least a coding tool of the coding tools comprises a plurality of configurable options within the coding tool, and at least the second syntax element indicates a subset of the plurality of configurable options that has the decoding complexity that is lower than the worst-case decoding complexity.

18. The method of claim 11, wherein the second syntax element is indicative of a decoding complexity budget that is chosen to generate the coded information, a decoding of the coded information being within the decoding complexity budget.

19. The method of claim 11, wherein the second syntax element indicates at least one of:
a profile mask;
a level indicator;
a tier indicator;
a memory restriction indicator;
a sample processing rate restriction indicator;
a bit processing rate restriction indicator;
a GPU processing rate restriction indicator;
a GPU memory restriction indicator;
a coding tool mask;
a CPU complexity indictor;
a GPU complexity indictor;
a memory complexity indicator;
a device restriction indicator;
a processor restriction indicator;
a device class restriction indicator;
a cooperative encoder indicator;
a cooperative encoder standard indictor;
a cooperative encoder CPU complexity budget indicator;
a cooperative encoder GPU complexity budget indicator; and/or
a cooperative encoder memory complexity budget indictor.

20. A non-transitory computer-readable storage medium storing instructions which when executed by a processor cause the processor to perform an encoding method, the encoding method comprising:
selecting, among coding tools that are available under a set of restrictions, a subset of coding tools, the subset of coding tools having a decoding complexity that is lower than a worst-case decoding complexity of the coding tools;
encoding at least a source picture into coded information in a video bitstream by using the subset of coding tools;
including, into the video bitstream, at least a first syntax element that is indicative of the set of restrictions, and at least a second syntax element that is indicative of the decoding complexity; and
transmitting the video bitstream.
